(19) United States
(12) Patent Application Publication
(10) Pub. No.: US 2021/0278271 A1
(43) Pub. Date: Sep. 9, 2021

(54) METHOD FOR DETERMINING THE PATH OF A MEASUREMENT BEAM OF AN INTERFEROMETRIC MEASURING DEVICE, AND MEASURING DEVICE FOR INTERFEROMETRIC MEASUREMENT OF AN OBJECT UNDER MEASUREMENT

(71) Applicant: Polytec GmbH, Waldbronn (DE)

(72) Inventors: Bernd ARMBRUSTER, Karlsruhe (DE); Matthias SCHUSSLER, Waldbronn (DE); Bernd HEINEN, Karlsruhe (DE)

(73) Assignee: Polytec GmbH, Waldbronn (DE)

(21) Appl. No.: 17/251,325

(22) PCT Filed: Jun. 5, 2019
(86) PCT No.: PCT/EP2019/064710

§ 371 Date: Dec. 11, 2020

(30) Foreign Application Priority Data
Jun. 15, 2018 (DE) 10 2018 114 479.2

(51) Int. Cl. G01H 9/00; G01B 11/16; G01B 11/25; G01S 17/58; G01S 17/87; G01S 17/894

(52) U.S. Cl. CPC G01H 9/00; G01B 11/161; G01S 17/894; G01S 17/58; G01S 17/87; G01B 11/25

(57) ABSTRACT

A method for determining the path of a measurement beam of an interferometric measuring device including the method steps: A. recording a plurality of spatially resolved images of the object under measurement; B. creating a three-dimensional model of the object under measurement; C. providing a measurement-head model; D. creating an association between coordinates in the three-dimensional model of the object under measurement and coordinates in the measurement-head model; E. determining the measurement beam path. A measuring device for interferometric measurement of an object under measurement is also provided.

### TECHNICAL FIELD

The invention relates to a method for determining the beam path of a measurement beam of an interferometric measurement apparatus and a measurement apparatus for interferometric measurement of a measurement object.

### BACKGROUND

Measurement apparatuses which have a beam source, preferably a laser beam source, a detector, a beam splitter and an evaluation unit are known for performing interferometric measurements on a measurement object. Here, an original beam generated by the radiation source is split into a measurement beam and a reference beam by the beam splitter. The measurement beam is guided to at least one measurement point on the measurement object and the measurement beam, which has been at least partially reflected or scattered by the measurement object, is superimposed with the reference beam on a detection surface of the detector such that a superimposition or interference signal between measurement beam and reference beam is measurable by the detector.

In order to capture vibration data from measurement objects, such measurement apparatuses are embodied as vibrometers, preferably as laser Doppler vibrometers. The frequency of the measurement beam is influenced by the movement or vibration of the object surface, and so conclusions can be drawn about the movement of the object, in particular the vibration frequency of the object surface, from the superimposed signal of the measurement and reference beam.

For a multiplicity of measurement situations, it would be desirable to determine not only the vibration frequency or vibration amplitude but also the direction of the vibration in the vibration data. By contrast, an interferometric measurement apparatus always records the vibration in the direction of the measurement beam when the measurement beam scattered or reflected by the measurement object runs back into itself (i.e., the optical axis of the measurement beam running toward the measurement object and the optical axis of the measurement beam returning from the measurement object are identical) and in direction of the angle bisector if the measurement beam scattered or reflected by the measurement object runs back at an angle to the incident measurement beam (and hence the optical axis of the measurement beam running toward the measurement object and the optical axis of the measurement beam returning from the measurement object include this angle).

Usually, interferometric measurement apparatuses in which the measurement beam scattered or reflected by the measurement object runs back into itself or virtually runs back into itself are used for vibration measurements. For these interferometric measurement apparatuses, it is therefore desirable to determine the beam path of the optical axis of the measurement beam running toward the object, in particular the angle of incidence of the measurement beam on the object at the measurement point, as the beam path of the measurement beam.

For interferometric measurement apparatuses in which the incident and returning measurement beams are at an angle to one another, it is accordingly desirable to determine the profile of the angle bisector at the measurement point, through which the incident beam and the returning beam and the bisector run, in particular the angle of the angle bisector relative to the object at the measurement point.

The term “beam path of the measurement beam” or “determination of the beam path of the measurement beam” thus designates here, and in the following, the path relevant to the measurement carried out by the measurement beam. The beam path therefore preferably contains the optical axis of the measurement beam running toward the measurement object, but equivalent information items can also be determined, in particular information items relating to an angle bisector as described above. To simplify the description in the present application, the following always refers to the beam path of the measurement beam, its angle of incidence, etc., but this always also includes equivalent information items, such as, e.g., the aforementioned angle bisector, instead of the measurement beam.

It is therefore desirable to determine the beam path of the measurement beam, in particular the angle of incidence of the measurement beam on the object at the measurement point. It is often desired to determine the vibration in the direction of the surface normal of a surface surrounding the measurement point. Using the angle of incidence, it is then possible to calculate the vibration component in the direction of the surface normal. Measuring systems that direct a plurality of measurement beams at a measurement point from different directions are also common. On the basis of the measurement beam paths of the measurement beams used for the measurement, the direction-dependent vibration can then be calculated via a transformation matrix; this is generally also referred to as a 3D measurement of a vibration. For this reason, it is very important to precisely capture the path of the measurement beam.

### SUMMARY

The present invention is therefore based on the object of allowing the user to determine the beam path of a measurement beam of an interferometric measurement apparatus in a simplified manner.

This object is achieved by a method and by a measurement apparatus having one or more features as described herein.

The method according to the invention is preferably designed to be carried out by the measurement apparatus according to the invention, in particular an advantageous embodiment thereof. The measurement apparatus according to the invention is preferably embodied to carry out the method according to the invention, in particular in a preferred embodiment thereof.

The method according to the invention for determining the beam path of a measurement beam of an interferometric measurement apparatus includes the following method steps:

In a method step A, a plurality of spatially resolved measurement object images of at least one measurement surface of the measurement object are recorded from different perspectives. In a method step B, a three-dimensional measurement object model which comprises at least the measurement surface of the measurement object is created by the plurality of spatially resolved images of the measurement surface. In a method step C, a measuring head model which comprises at least the measurement beam exit opening of the measuring head and/or an element fixedly connected thereto is provided. In a method step D, a mapping between coordinates in the three-dimensional measurement object model and coordinates in the measuring head model is created with the aid of a first structure in the measurement object model and a second structure in the measuring head model and on the basis of a spatial relationship between the first and second structure. In a method step E, the measurement beam path is determined by carrying out at least two of the following steps:

Ei. determining the coordinates of at least one location, which is located on the optical axis defined by the measurement beam or which is in specified fashion spatially related thereto, on the basis of the measuring head model;

Eii. determining the direction vector specified by the measurement beam propagation direction on the basis of the measuring head model;

Eiii. determining the coordinates of the measurement beam point of incidence of the measurement beam and/or at least one auxiliary beam point of incidence of an auxiliary beam on the measurement object which is in specified fashion spatially related to the measurement beam on the basis of at least one spatially resolved image which comprises the measurement beam point of incidence and/or the at least one auxiliary beam point of incidence on the measurement object.

Here, the scope of the invention includes the method steps described above being carried out in a different order and/or method steps being combined and/or one method step being integrated into another method step.

Using the method according to the invention, the beam path of the measurement beam can consequently be determined, with use being made of the three-dimensional model, created in method steps A and B, of at least the measurement surface of the measurement object. This results in a considerable simplification for the user, since method step A can be carried out by the user in an uncomplicated manner and, on the basis thereof, the beam path can be determined automatically.

The beam path thus provides further information items, in particular the angle of incidence of the measurement beam at the measurement point of the object in the three-dimensional model, i.e., in a coordinate system of the measurement object, and so there can be additional processing of the measurement data on the basis of the data of the beam path.

Recording the spatially resolved images from different perspectives in method step A facilitates a much more precise creation of a three-dimensional measurement object model: Spatial coordinates in two dimensions can be determined in many measurement situations from recordings of a spatially resolved image from just one perspective. However, a precise determination of a three-dimensional model and, in particular, of spatial coordinates in three dimensions is particularly relevant for the present invention. Here, the invention has the particular advantage that, as a result of recording of spatially resolved images from different perspectives in method step A, the three-dimensional model according to method step B facilitates a significantly higher accuracy, particularly in three spatial dimensions. This also makes the determination of the beam path correspondingly more accurate. The design of method step A according to the invention by the recording of spatially resolved images from different perspectives consequently forms the basis for a user-friendly and precise determination of the beam path.

The measurement surface can be a partial area of the surface of a measurement article. Likewise, the spatially resolved images can additionally include the region surrounding the object to be measured, for example an installation area for the measurement article and/or a background area. The measurement object can thus also comprise one or more measurement articles and one or more areas, in particular installation areas or background areas. The measurement surface can thus also include areas that are not the surface of a measurement object. The scope of the invention includes one or more measurement points being arranged on an area that is not the surface of a measurement article, for example on a background or installation area. Preferably, the measurement surface comprises at least the region of the measurement article or articles, in which measurement points should be arranged during a subsequent interferometric measurement.

A three-dimensional model of at least the measurement surface of the measurement object is available after method step B has been carried out. It is consequently not necessary for the user to carry out their own measurements or specify certain reference points manually. Likewise, it is not necessary to additionally specify three-dimensional models created elsewhere, such as CAD models.

The object on which the invention is based is also achieved by a measurement apparatus for interferometric measurement of a measurement object having one or more of the features described herein.

The measurement apparatus according to the invention for interferometric measurement of a measurement object comprises one or more beam sources for generating at least one measurement beam and at least one reference beam, a detector and an evaluation unit. The measurement beam is guided to at least one measurement point on the measurement object and the measurement beam, which has been at least partially reflected or scattered by the measurement object, is superimposed with the reference beam on a detection surface of the detector such that a superimposition or interference signal between measurement beam and reference beam is measurable by the detector.

Preferably, the measurement apparatus comprises a beam source, in particular a laser beam source, and at least one beam splitter. In this preferred embodiment, an original beam generated by the beam source is split into the at least one measurement beam and at least one reference beam by the beam splitter. The beam source is consequently preferably embodied as a laser beam source; the original beam is therefore preferably a laser beam.

The frequency of the measurement beam is influenced by the movement or vibration of the object surface, and so conclusions can be drawn about the movement of the object, in particular the vibration frequency of the object surface, from the superimposed signal of the measurement and reference beam.

The measurement apparatus is consequently embodied as an interferometric measurement apparatus. The measurement apparatus is preferably embodied as a vibrometer, in particular as a laser Doppler vibrometer.

What is essential is that the evaluation unit is embodied to determine the beam path of the measurement beam. Here, the measurement apparatus is preferably embodied to:

A. record a plurality of spatially resolved measurement object images of at least one measurement surface of the measurement object from different perspectives by the image recording unit;

B. create a three-dimensional measurement object model which comprises at least the measurement surface of the measurement object by the plurality of spatially resolved images of the measurement surface;

C. provide a measuring head model which comprises at least one measuring head element which is in specified fashion related to the measurement beam;

D. create a mapping between coordinates in the three-dimensional measurement object model and coordinates in the measuring head model with the aid of a first structure in the measurement object model and a second structure in the measuring head model and on the basis of a spatial relationship between the first and second structure;

E. determine the measurement beam path by carrying out at least two of the following steps by the evaluation unit:

Ei. determining the coordinates of at least one location, which is located on the optical axis defined by the measurement beam or which is in specified fashion spatially related thereto, on the basis of the measuring head model;

Eii. determining the direction vector specified by the measurement beam propagation direction on the basis of the measuring head model;

Eiii. determining the coordinates of the measurement beam point of incidence of the measurement beam on the measurement object on the basis of at least one spatially resolved image which comprises the measurement beam point of incidence on the measurement object and/or at least one auxiliary beam point of incidence of an auxiliary beam which is in specified fashion spatially related to the measurement beam.

The measurement apparatus is consequently particularly preferably embodied to carry out the method according to the invention, in particular a preferred embodiment thereof.

The advantages mentioned above when explaining the method according to the invention are achieved here.

In method step A, a plurality of spatially resolved measurement object images of at least one measurement surface of the measurement object are recorded from different perspectives. The plurality of spatially resolved measurement object images can be recorded by one or more image recording units. In an advantageous embodiment, the plurality of spatially resolved images are recorded by a movable image recording unit, in particular an image recording unit that is moved by the user.

Digital cameras, in particular cameras with a CCD or CMOS image sensor, are preferably used as the image recording unit, particularly in method step A and/or C. The scope of the invention also includes the case of creating the respective spatially resolved image by a scanning method: The scope of the invention includes the use of an image recording unit in which individual points of the object to be imaged are recorded in succession and a spatially resolved image is constructed from a plurality of separately recorded points, for example by a computer unit.

The image recording unit can also comprise an illumination unit which illuminates the measurement object while the image recording unit records images. Thus, image recording units for capturing the three-dimensional shape of an object, which comprise a pattern projection unit, in particular a stripe projection unit and a camera, typically a black-and-white camera, are known, wherein the camera is used to accurately capture a light pattern projected on the object by the projection unit. Preferably, such an image recording unit is used to carry out method step A.

Particularly preferably, the image recording unit also comprises a color camera for recording a color image in order to assign a realistic, in particular colored and/or textured image representation of the actual surface of the model to the surface of a created three-dimensional model of the object. The use of such image recording units is particularly advantageous for carrying out method step A.

Advantageously, use is therefore made of an image recording unit which, as described above, comprises a projection unit for projecting a pattern, in particular a stripe pattern, on the object and an assigned camera, in particular a black-and-white camera. A spatially resolved image is consequently captured with this camera when the pattern is projected, and so a three-dimensional model can be created from the plurality of spatially resolved images in a manner known per se, in particular according to the method of striped light projection. A further camera, in particular a color camera as described above, is preferably used additionally to record a further camera image, in particular a color image, for recording the texture of the object, preferably without a stripe projection taking place, this further camera image being recorded simultaneously with a spatially resolved image, or at a short time interval thereafter. In particular, it is consequently particularly advantageous to alternately record in each case a spatially resolved image with stripe projection and, in particular at a short time interval thereafter, a color image without projection of the stripe pattern: The above-described image recording unit records both images with projected stripes and images without the stripes in quick succession. The images without the stripes contain the spatially resolved appearance of the measurement object (texture). Supported by the brief time interval between the recordings, the 3D coordinates determined by the stripe projection can each be assigned pixels of the texture.

Conversely, 3D coordinates can be assigned to a pixel of the texture.

In this way, texture information, which corresponds to the actual optical impression of the surface of the model, can also be assigned to the three-dimensional model. Due to the short temporal interval, the perspective and position of the images recorded in quick succession are identical or only slightly different, even if, for example, the user, using a hand-held model, moves the latter relative to the object.

The use of image recording units which comprise a plurality of spatially resolved image detectors is also within the scope of the invention, with the spatially resolved image of the image recording unit being created by suitable combination of the image information from the plurality of image detectors.

In an advantageous embodiment, at least one spatially resolved image of at least one partial area of the measurement object is recorded using an image recording unit, said image comprising the measurement beam point of incidence and/or the auxiliary beam point of incidence while the beam impinges on the point of incidence. The point of incidence can thus be localized in this spatially resolved image. The localization is preferably implemented by ascertaining the image coordinates of the point of incidence, an x,y position or an image pixel localization of the point of incidence in the spatially resolved image or a combination thereof, particularly preferably as explained in more detail in FIG. 9 and the description of the figures. For typical illumination situations, the point of incidence impinged on spatially resolved image by the beam has a higher intensity, in particular a greater brightness, in comparison with the surrounding picture elements. The point of incidence is consequently localized in an advantageous embodiment by localizing the picture element with the greatest light intensity.

In the majority of typical measurement situations, the beam has a different color than the surface of the measurement object. Therefore, the point of incidence is localized in an advantageous embodiment by localizing a colored spot in the color of the measuring or auxiliary beam.

Likewise, it is possible to capture a spatially resolved image in which the point of incidence is not impinged upon by the beam and the intensity values are compared with a further spatially resolved image in which the point of incidence is impinged upon by the beam. In particular, the point of incidence can be localized by forming the difference between the brightness values in a spatially resolved manner when the two aforementioned images are compared. In a further advantageous embodiment, the point of incidence is therefore localized by comparison, in particular forming the difference, with a further spatially resolved image which comprises the point of incidence not impinged upon by the beam.

What is advantageous, in particular, is that the spatially resolved image which has the point of incidence impinged upon by the beam is one of the measurement object images for creating the three-dimensional model in method step B. This renders the coordinates of the point of incidence in the measurement object model determinable in a simple manner, and so method step Eiii can be carried out in a simple manner.

In method step B, a three-dimensional measurement object model which comprises at least the measurement surface of the measurement object is created by the plurality of spatially resolved images of the measurement surface as per method step A. The creation is preferably implemented by the use of photogrammetry. The object on which the invention is based is thus also achieved through the use of photogrammetry to determine the beam path of a measurement beam of an interferometric measurement apparatus.

Photogrammetric methods are known per se from geodesy and remote sensing. In the meantime, however, photogrammetry is also used to ascertain the spatial position and/or the three-dimensional shape of an object by a plurality of spatially resolved measurement images.

To facilitate a precise determination of the three-dimensional model, the spatially resolved images are preferably captured in such a way that, at least in the edge regions, there is an overlap with the respective subsequent image. On account of the typical size of the measurement objects for which the method according to the invention is used, the use of processes of close-range photogrammetry, in particular, is advantageous:

One possible embodiment is the determination of unambiguous features in the spatially resolved images and the subsequent triangulation of coordinates.

Identifiable features are determined in the spatially resolved images by scale-invariant feature transform SIFT, in particular according to U.S. Pat. No. 6,711,293 B1, speeded-up robust features SURF and similar relevant known methods. These features are searched for in a plurality of the spatially resolved images and assigned to one another. The assignment is carried out by an algorithm that determines roughly matching neighbors for the features in a multidimensional space spanned by the feature vectors (SIFT, SURF, etc.). Examples of this are simple trial and error (brute force) or the Fast Library for Approximate Nearest Neighbor Search (FLANN: Marius Muja and David G. Lowe, “Fast Approximate Nearest Neighbors with Automatic Algorithm Configuration”, in International Conference on Computer Vision Theory and Applications (VISAPP'09), 2009). Other methods are also conceivable. Based on the imaging properties of the image recording unit used, the perspectives of the images can then be calculated and, coordinates can be ascertained on the basis of the feature correspondences and preferably by triangulation. Carrying out this coordinate ascertainment multiple times results in a plurality of 3D coordinates, which are combined to form a model. This corresponds to method step B. An overview of this and other available such methods can also be found at https://en.wikipedia.org/wiki/Structure_from_motion.

Another possible embodiment here is the use of the aforementioned pattern projection known per se, preferably in the embodiment of a stripe projection. In the case of the pattern projection, the time-consuming search for suitable neighbors in a plurality of the spatially resolved images is dispensed with, and the triangulation can be implemented on the basis of the known relationship between the pattern projection unit and camera. Here, too, a plurality of 3D coordinates are obtained, which are combined to form a model in accordance with method step B. Movable apparatuses for recording a plurality of spatially resolved images of an object and creating a three-dimensional model are already commercially available. In addition to a recording unit, in particular a camera, for capturing the spatially resolved image, the image recording units typically also comprise a projection unit for projecting a pattern, in particular for projecting stripes for the method of striped light projection.

One of the commercially available 3D scanners specified below is preferably used to this end (the names specified below are trade names whose rights reside with the respective proprietors): Artec Eva, Artec Spider, Creaform GoScan 3D, Creaform Handyscan 3D, Creaform Metrascan 3D.

Using these image recording units and the above-described method, it is consequently possible, in particular, to assign spatial coordinates in the 3D model to a picture element of a spatially resolved image which shows at least part of the 3D model. Therefore use is advantageously made of a spatially resolved image, which contains the measurement beam point of incidence and/or an auxiliary beam point of incidence, as described above in order to determine the spatial coordinates of the point of incidence in the measurement object model.

In method step C, a measuring head model is provided which comprises at least one measuring head element which is in specified fashion related to the measurement beam.

The measuring head model is used to facilitate an assignment of geometric data of the measurement beam to the three-dimensional measuring head model, as explained in more detail below. The measuring head model therefore comprises at least one measuring head element which is in specified fashion related to the measurement beam. Furthermore, the position and alignment of the measuring head element in the measuring head model is preferably specified; in particular, a coordinate system of the measuring head model is defined via locations of the measuring head element.

In the context of this application, “specified” means that the corresponding information is available and can be used; by way of example, it is stored on a data memory and can be read out using a corresponding reader for further processing of the information. Likewise, specified information can follow from further described method steps and can be specified as a result of these method steps, in particular by way of preferred embodiments of the method according to the invention which contain such method steps.

Examples of measuring head elements and an assigned specified relation to the measurement beam are listed below as preferred embodiments of method step C:

| Measuring head element | Specified relationship |
|---|---|
| Exit opening of the measuring head | Position of the measurement beam |
| for the measurement beam, for | exit within the exit opening |
| example the edge of the exit | |
| opening, which is defined by a | |
| circle. | |
| Exit opening of the measuring head | Direction vector of the |
| for the measurement beam, for | measurement beam based on a |
| example the edge of the exit | normal to the plane, which |
| opening, which is defined by a | is defined by the edge of the exit |
| circle. | opening in the example. |
| | The measurement beam path then |
| | is completely defined, particularly |
| | in combination with the position |
| | of the measurement beam exit. |
| Element on the housing of the | Position of the measurement beam |
| measuring head or an element | exit relative to the element. |
| fixedly connected to the measuring | |
| head. | |
| These are, for example, edges or | |
| depressions in the housing. | |
| Element on the housing of the | Direction vector of the |
| measuring head or an element | measurement beam based on the |
| fixedly connected to the measuring | given reference element. |
| head. These are, for example, edges | The measurement beam path then |
| or depressions in the housing. | is completely defined, particularly |
| | in combination with the position |
| | of the measurement beam exit. |
| Element on the housing of the | Distance of the element to the |
| measuring head or an element | measurement beam and/or an angle |
| fixedly connected to the measuring | which the element includes with |
| head. These are, for example, edges | the measurement beam, in |
| or depressions in the housing. | particular that the element extends |
| | parallel to the measurement beam |
| Securable alignment element, for | Distance of the element to the |
| rotating, tilting and/or moving the | measurement beam, in particular |
| measuring head | to the center of rotation. |

In a further preferred embodiment, light beams which in specified fashion are spatially related to the measurement beam represent measuring head elements. Such light beams can be auxiliary beams and/or further measurement beams. In this preferred embodiment, the measuring head model consequently contains the spatial arrangement of the light beams relative to one another and to the measurement beam as information. It is therefore not mandatory for the measuring head model to contain information items about a physical measuring head element.

In an advantageous embodiment, a measuring head model is therefore provided in method step C, said model having a light beam, in particular a measurement and/or auxiliary beam, at least as a measuring head element and said light beam in specified fashion being related to the measurement beam.

The light beams and the spatial arrangement thereof relative to the measurement beam consequently preferably represent a second structure in the measuring head model for the assignment described below in relation to method step D. The information about the spatial arrangement of the light beams relative to the measurement beam can be specified in a manner known per se, in particular via spatial coordinates and/or vectors in a measuring head coordinate system. The scope of the invention also includes the specification in any other way, in particular by one or more mathematical formulas. By way of example, if the spatial coordinates of points of incidence of the light beams are known or ascertained as described below, a closed mathematical formula can be specified on the basis of the knowledge of the spatial arrangement of the light beams relative to the measurement beam, said formula yielding an information item about the beam path of the measurement beam, for example an angle of incidence of the measurement beam, on the basis of the coordinates of the points of incidence. In this case, the measuring head model is consequently given by the mathematical formula.

Preferably, the measuring head element is stored as a complete schematic representation of the measuring head in which the path of the measurement beam is defined. When used later in method step C, in particular in method step C3 described below, the portions that are not required can then be masked.

The measuring head model thus facilitates the determination of data about the beam path of the measurement beam, at least in the measuring head model. Therefore, a least one of the following determinations is preferably carried out in method step C, very particularly preferably both of the following determinations:

a) determining the coordinates of at least one location in the measuring head model, which location is located on the optical axis defined by the measurement beam or which location is in specified fashion spatially related thereto, and/or

b) determining the direction vector specified by the measurement beam propagation direction in the measuring head model or a second location in the measuring head model, which location is located on the optical axis defined by the measurement beam or which location is in specified fashion spatially related thereto.

The determination is implemented using the specified relationship between the measuring head element and the measurement beam. As described above, the specified relationship can be specified directly as a spatial relation between the measuring head element and a location according to a) and/or a propagation direction or a second location according to b).

Likewise, the specified relationship can alternatively or additionally lead to a determination of data about the beam path, in particular according to a) and/or b), via further method steps, as explained below with reference to further advantageous embodiments C1, C2, C3 and C4 of method step C:

In a preferred embodiment, the measuring head model is provided in a method step C1 using the following method steps Ci. and Cii.:

Ci. recording a plurality of spatially resolved measuring head images, which at least comprise the measuring head element, from different perspectives;

Cii. creating a measuring head model by the plurality of spatially resolved measuring head images.

In the advantageous embodiment with method step C1., this consequently yields the advantage that the data required to provide the measuring head model are at least partially, preferably completely, captured by recording the spatially resolved measuring head images. In particular, in a further advantageous embodiment, the creation of the measuring head model can be implemented in a manner analogous to method steps A and B: The scope of the invention includes all spatially resolved images according to method step A and method step C being captured by a common image recording unit. The use of different image recording units for creating the spatially resolved images is also within the scope of the invention, in particular a first image recording unit for carrying out method step A and a second image recording unit for carrying out method step C (in particular Ci.).

In a further advantageous embodiment, which is uncomplicated for the user, method step C is integrated into method step A.

The spatially resolved images for creating the measuring head model are preferably recorded by an image recording unit mentioned in method step A. The three-dimensional model is preferably created by photogrammetry, particularly preferably as described in method step B.

In the advantageous embodiment C1, the spatial relation of the measurement beam to the measuring head model can be specified in various ways: The scope of the invention therefore includes a user manually selecting a point on the optical axis of the measurement beam, in particular an exit point of the measurement beam on the measuring head, in one or more of the images recorded in Ci or in the measuring head model from Cii, in particular by selecting it on a display unit, for example by a mouse. The scope of the invention also includes the measuring head element being determined in the measuring head model using image processing methods. To this end, the measuring head preferably has optically prominent features for identification, in particular one optical marker or, preferably, a plurality of optical markers. In an advantageous embodiment, the measuring head has optical markers which facilitate identification of the exit opening for the measurement beam. Such optical markers can be embodied in the manner of a crosshair, at the center of which the exit opening is located. The optical markers such as the crosshair can be identified in the measuring head model using image processing algorithms known per se, and so the position of the measurement beam exit opening in the measuring head model can be identified automatically. In a further advantageous embodiment of method step C1, an alignment model is used to specify the spatial relationship, as described below for method step C3.

The data about the beam path in method step C can be determined using a specified model: In a further advantageous embodiment, a specified model, in particular a model stored on a storage medium and read out therefrom, is provided in a method step C2. In some measurement situations, three-dimensional models of the measuring head or at least of parts of the measuring head, in particular a measuring head element, are already available. This is the case, for example, if CAD or FE models have already been created for the construction of the measuring head. In an advantageous embodiment, a specified model is therefore used as method step C2 in an embodiment of method step C that is economical in terms of method. This is particularly advantageous in combination with a plurality of measurement beams and/or a plurality of auxiliary beams, as described further below.

In a further advantageous embodiment of method step C as method step C3, an alignment model of the measuring head which at least schematically comprises at least a part of the measuring head is specified.

In an advantageous embodiment, the alignment model comprises a specified model, for example based on CAD data, FE data or previous steps for providing a measuring head model as described above. In a further advantageous embodiment, the alignment model comprises a schematic structure of the measuring head, in particular only a schematic structure of the measuring head. In this advantageous embodiment, the shape of the measuring head or of parts of the measuring head is only specified in an abstract manner. Measuring heads often have simple geometric shapes. In particular, approximately cylindrical or cuboid measuring heads are known, or measuring heads whose shape can be approximated by a combination of a few cylinders and cuboids. In a manner particularly economical in terms of the method, an approximately geometric structure, such as a cylinder or cuboid or a combination of cylinders and cuboids, can therefore be specified as the alignment model. In contrast to method step C2, there also is an alignment of the alignment model with a measuring head model, which was created by capturing a plurality of spatially resolved images from a plurality of perspectives, in particular as described for method steps Ci and Cii, in the advantageous embodiment according to method step C3.

The alignment model includes a specified relation to the measurement beam as additional information. The specified model thus contains the measuring head element according to method step C or represents the measuring head element according to method step C. In contrast to method step C2, method step C3 additionally includes an alignment with the aforementioned model based on the spatially resolved images from a plurality of perspectives, and so the result is an overall measuring head model which comprises the model based on the plurality of spatially resolved images from different perspectives and the information from the alignment model, in particular with the specified relation to the measurement beam.

The alignment with the alignment model is preferably implemented using method steps known per se:

In this case, the procedure is preferably divided into two sequential steps. First, the transformation (rotation and translation) which transforms the alignment model into the measuring head model is determined. This process is generally referred to as global registration. Subsequently, transformation is refined in such a way that the point clouds of the measuring head model and the alignment model are brought into the best possible congruence. On the basis of the determined transformation, it is possible to subsequently transform all points and vectors linked to the alignment model into the measuring head model, e.g. measurement beam exit point, measurement beam path or auxiliary beam exit point and path.

Global registration can be implemented, for example, by way of fast point feature histograms (FPFH) (DOI: 10.1109/ROBOT.2009.5152473). These represent points with their local properties (surrounding points, surface normals, etc.) in a multidimensional space. These FPFH are calculated both for the alignment model used and for the measuring head model, and point correspondences are selected in an iterative process and the resulting transformation is calculated. As a rule, the deviations following this step are so small that the transformation can be refined in a second step without using FPFH.

For initially roughly aligned models, an iterative closest point (ICP) algorithm is often applied to improve the alignment, e.g., according to DOI: 10.1109/IM.2001.924423. From the point cloud of the measuring head model, it determines the points with the smallest distance in the alignment model and adapts the transformation such that their distance is minimized (point-to-point). The selected points are filtered using a limit value. The transformation is improved over a plurality of iteration steps and more and more points are selected and brought into congruence. In addition to the point spacing, the surface normal can also be used (point-to-plane).

Conversely, the measuring head model can also be transformed into the alignment model. The results are equivalent.

Alignment models can be derived from CAD models, for example. Here, points are interpolated on the known surfaces and, where necessary, the surface normal for each point is calculated using the triangles.

Alternatively, a schematic alignment model which describes the measuring head using basic geometric objects (cuboid, cylinder, sphere, etc.) can be stored. For the basic objects, points of any density can be calculated on their surfaces and the surface normal can also be determined.

The use of a combination of CAD model and schematic alignment model is described below as an exemplary embodiment. A CAD model of the entire measuring head and a lens of the measuring head are used as a schematic model:

1. Calculation of the FPFH both for the CAD model (alignment model) and for the measuring head model

2. Global registration of both model

3. Refinement of the transformation by the ICP algorithm

4. Further refinement of the transformation by the ICP algorithm using the schematic model.

In a further advantageous embodiment in the form of method step C as method step C4, a measuring head model additionally containing measurement data is provided. In this advantageous embodiment, a holding apparatus containing at least one position detector is used for the measuring head. The measuring head is arranged on the holding apparatus in such a way that the position of the measuring head can be changed relative to the holding apparatus and the position and/or the change in position is detected by the position detector. The scope of the invention includes the measuring head being arranged on the holding apparatus so as to be rotatable around one or preferably two axes and the position detector accordingly detecting a rotation of the measuring head about one or two axes. As an alternative or in addition thereto, the scope of the invention includes the position head being arranged on the holding apparatus so as to be displaceable, in particular displaceable in translation, and the position detector accordingly detecting the location and/or the distance of the translational displacement.

In this advantageous embodiment, a model which comprises at least one element which is in specified fashion related to the holding apparatus is preferably provided. Furthermore, data are preferably specified, by which it is possible to determine, on the basis of the measurement data of the position detector, a spatial relation of the measurement beam to the holding apparatus or to at least the aforementioned element which is in specified fashion related to the holding apparatus.

In the advantageous embodiment according to method step C4, it is therefore sufficient to assign to the measurement object model the holding apparatus or an element with a specified relation to the holding apparatus, in particular with coordinate mapping as described below for method step D. The spatial association between the holding apparatus and the measurement beam in method step E is implemented with the additional aid of the measurement data from the position detector and the specified information in order to derive from the measurement data the spatial relationship between the measurement beam and the holding apparatus or the element with a specified spatial relation thereto.

The above-described advantageous embodiments C1 to C4 can be chosen as alternative embodiments. Likewise, the scope of the invention includes the combination of two or more embodiments. In particular, as described above, the combination of method steps C1 and C3 is advantageous since a plurality of spatially resolved images of at least the measuring head element are recorded according to method step Ci in a manner that is uncomplicated for the user, in particular a measuring head model has already been created according to Cii; however, a spatial relation of the measuring head element to the measurement beam is specified by the alignment model, which in particular can already be specified by the manufacturer.

The three-dimensional measurement object model and/or the measuring head model, preferably both models, are advantageously embodied for capturing the shape of three-dimensional objects, in the type known per se from photogrammetry.

In particular, the scope of the invention includes the creation in method step B of a three-dimensional model which has a point cloud or preferably a polygon mesh, in particular an irregular triangular mesh. As described above, the three-dimensional model further preferably comprises texture information items of the object, in particular one or more spatially resolved images of the appearance of the measurement surface and further preferably also the associated picture element coordinates in the spatially resolved images of the measurement surface (so-called texture coordinates) for each point of the surface with 3D coordinates.

The three-dimensional model therefore preferably comprises a list of points on the surface of the object, each with 3D coordinates and texture coordinates, and a list of triangles which approximate the surface of the measurement object, in which the vertices are constituents of the list of points and the texture information of the surface is represented by the triangles, preferably by projection onto the triangles.

In an advantageous embodiment, the measurement apparatus according to the invention has a focusing device for the measurement beam. This is advantageous in order to impinge on a precise measurement point, in particular with the smallest possible extent, on the measurement object. Typically, different measurement points have different distances from the measurement apparatus, and so the focusing unit needs to be set to the respective measurement point, preferably automatically by an associated control unit, which is optionally connected to the evaluation unit ascertaining the measurement beam path.

A high precision of the three-dimensional model is desirable for this advantageous embodiment. This demonstrates a further advantage of the method according to the invention as a particularly precise determination of the three-dimensional model according to method step B is possible as a result of spatially resolved images being recorded from a plurality of perspectives according to method step A.

In an advantageous embodiment of the method according to the invention, the method is carried out for a plurality of measuring heads, preferably by a common measurement object model. In this advantageous embodiment, the beam path can thus be ascertained for a plurality of measuring heads with a plurality of measurement beams, with, however, only one measurement object model having to be created.

Advantageously, a common measuring head model is provided for all measuring heads in method step C. As a result thereof, the measurement beams of the measuring heads are already related to one another in a manner that is economical in terms of the method as a result of the common measuring head model for all measuring heads.

Once the beam path has been determined for a measurement beam, the beam path of the other measurement beams can also be determined on the basis of the aforementioned relationship of the measurement beams, in a manner that is economical in terms of the method.

The measuring head model thus allows the beam path to be determined in the coordinate system of the measurement object, provided that there is coordinate mapping between the measuring head model and the measurement object model, as described below.

In method step D, a mapping between coordinates in the three-dimensional measurement object model and coordinates in the measuring head model is created with the aid of a first structure in the measurement object model and a second structure in the measuring head model and on the basis of a spatial relationship between the first and the second structure.

Consequently, the two models are related to one another using method step D. As a result, it is possible to convert any coordinates in the measurement object model into coordinates of the measuring head model, and vice versa.

The coordinate systems of the models can be chosen in a manner that is usual per se. In particular, the use of a Cartesian coordinate system is advantageous, but the use of other coordinate systems also lies within the scope of the invention, for example cylindrical coordinates or spherical coordinates.

It is therefore essential for method step D that a spatial relationship between the first and the second structure is known or ascertained. The corresponding mapping between the coordinates in the measurement object model and in the measuring head model is implemented by way of this spatial relationship. This is a further advantage of the method according to the invention: By using the measurement object model and the measuring head model, the mapping according to method step D can be carried out in partially or fully automated fashion, thus increasing the user friendliness. A number of ways of creating the mapping between the coordinates as described above lie within the scope of the invention, with the invention not being restricted to the advantageous embodiments mentioned below:

In one advantageous embodiment of method step D as method step D1, the first structure is identical to the second structure. In this case, the specified spatial relationship between the first and second structure is therefore the identity of the structures. As a result, the coordinates can be transformed from the measurement object model to the measuring head model, and vice versa, in a particularly simple manner.

The measurement object model and the measuring head model are advantageously created as a common model. In this way, structures that are present in both models are captured in an uncomplicated manner.

In particular, in an advantageous embodiment according to method step D1, it is advantageous to create the measuring head model on the basis of spatially resolved images, particularly preferably according to one or more of method steps C1, C3 and/or C4.

In a particularly user-friendly embodiment thereof, the user creates a multiplicity of spatially resolved images of the measurement object, at least of parts of the measuring head and the area in between, by an image recording unit. In this way, a common model is created in a simple manner, said common model consequently containing at least one structure, preferably a plurality of structures, which are part of both the measuring head model and the measurement object model. When the common model is created, a common coordinate system emerges directly for the measurement object and the measuring head.

One or more optical markers are additionally used in a further advantageous embodiment of the aforementioned method step D1. Such markers are advantageous in that they form an easily processable optical structure for creating a model. For example, such markers can be arranged on a fixed object and/or in the space between the measuring head and the measurement object such that simple user guidance is possible and the user only has to be instructed to firstly capture spatially resolved images which comprise the measurement object and the marker or markers and secondly capture spatially resolved images which comprise the measuring head or the measuring head element and the marker or markers. This is particularly advantageous in the case of a time-offset creation of the common model:

Thus, the user can initially configure the measurement object, in particular align one or more measurement articles, and subsequently record spatially resolved images of the measurement object and the marker or markers. Then, the user can position the measuring head and record spatially resolved images of the measuring head or the measuring head element and the marker or markers. If a correction is now to be made to the measurement object or the measuring head, only those spatially resolved images in whose model a correction was made need to be newly recorded: If, for example, the measuring head is repositioned or aligned differently, it is only necessary to record spatially resolved images of the measuring head or the measuring head element and the marker or markers, and not new spatially resolved images of the measurement object.

In an advantageous embodiment of method step D which is an alternative to D1, in particular as method step D2 as described below, the first and second structures are spaced apart from one another; in particular, the first and second structures advantageously do not overlap.

Nevertheless, a spatial relationship between the first and second structure is also specified in this advantageous embodiment. The spatial relationship can be specified in different ways, as explained below using further exemplary embodiments. A substantial advantage is that, in contrast to the embodiment according to D1, a spatial distance between the measurement object and the measuring head can be bridged without the user having to capture spatially resolved images in a contiguous region between the measurement object and the measuring head. Consequently, a region between the measurement object and the measurement article is bridged by specifying the spatial relationship between the first and second structure.

Advantageously, in the embodiment according to a method step D embodied as method step D2, use is made of a bridging object which has the first structure in a first portion and the second structure in a second portion. Furthermore, the spatial relationship between the first and second structure is specified by the bridging object. In this advantageous embodiment, the user arranges the measurement object, bridging object and measuring head in such a way that, to carry out method step A, it is only necessary to create spatially resolved images which include the measurement object and the first structure of the bridging object and, to carry out method step C, it is only necessary to create spatially resolved images which comprise the measuring head or the measuring head element and the second structure of the bridging object.

The bridging object is preferably embodied as a physical object, particularly preferably as a movable object. In particular, it is advantageous to use an elongate element, in particular a rod, with, preferably, the first structure being arranged in one end region of the elongate element and the second structure being arranged in the other end region of the elongate element. The bridging object preferably has sufficient stability so that a known spatial relation between the first and second structure remains unchanged, even in the case of movement or when subjected to other usual mechanical loads. In particular, the bridging object can be embodied as a rod, preferably made of plastic or metal, which has the first and second structure in end regions as mentioned above.

Alternatively, the bridging object can be formed by fixed objects: In a preferred embodiment, the spatial relation between two fixed structures that are spaced apart from one another is specified. Thus, in an advantageous embodiment, a spatial relationship between structures can be specified on fixed elements such as furnishings and/or walls, ceiling and/or floor. Consequently, in this advantageous embodiment, the user only needs to record spatially resolved images which include the measurement object and the first structure to carry out method step A and spatially resolved images which include the measuring head or the measuring head element and the second structure to carry out method step C. In a particularly simple embodiment, the first and second structure can be embodied by optical markers that are fixedly attached to furnishings, walls, floor and/or ceiling, in particular as described above. In this way, the spatial relationship between the optical markers can be measured once in a user-friendly manner and, as a result thereof, the spatial relationship between the first and second structure formed by the markers can be specified for all measurements in this environment.

The mapping in method step D can be implemented in an advantageous embodiment as method step D3 by determining the points of incidence of a plurality of beams on the measurement surface and knowing the relative path of these beams to one another:

If the coordinates of the points of incidence of a plurality of beams on the measurement surface are known and, moreover, the beam path in the measuring head coordinate system is known for each beam, method step D can also be carried out on the basis of this information, in particular according to the advantageous embodiment described below.

Such beams can, for example, represent the measurement beams of a plurality of measuring heads, each with a fixed spatial relation to structures in the measuring head model such as, e.g., the light exit openings and the housings or the like (via which, e.g., a point on the beam and the beam direction is defined, i.e., the beam path is defined in any case). Here, the points of incidence of the measurement beams on the measurement object define the first structure and the structures described by way of example, in particular one or more measuring head elements as described above in the measuring head model, define the second structure.

As described above, the beams themselves can likewise represent the second structure: As already stated, a measuring head model can also be specified by specifying the spatial arrangement of the beams relative to the measurement beam.

The assignment of the structures in the measurement object model to the structures in the measuring head model is implemented by way of the beam paths assigned to the structures in the measuring head model, with the structures in the measurement object model being specified in the measurement object coordinate system and the structures in the measuring head model and the associated beam paths being specified in the measuring head coordinate system and the mapping carried out in method step D being implemented by a coordinate transformation between the measuring head coordinate system and the measurement object coordinate system. This consists of translations and rotations, which can be described with the aid of suitable translation and rotation matrices when Cartesian coordinate systems are used. The description may be more complex in the case of different types of coordinate systems, but the coordinate transformation nevertheless still includes the same translations and rotations. In order to be able to specify the required coordinate transformation, essentially six independent transformation parameters have to be determined, which can easily be interpreted as three translational and three rotational degrees of freedom in the case of Cartesian coordinate systems. All coordinates in the measurement object coordinate system can be converted into coordinates of the measuring head coordinate system, and vice versa, using these initially unknown transformation parameters. It is now the remaining task of method step D to ascertain the described transformation parameters. To this end, use can now be made of a sufficient number of equations which contain these parameters and each establish relations between them that are independent of one another, and so the sought-after parameters can be determined on the basis of these equations in a mathematically known manner. Specifically, the beam points of incidence on the measurement object are used for this purpose having been determined according to method step Eiii, preferably with the aid of one of the advantageous embodiments described there. Their coordinates are therefore already completely known in the measurement object coordinate system.

Moreover, the measurement beam paths are available in the measuring head coordinate system. Hence, there is a search for the transformation of the measuring head coordinate system into the measurement object coordinate system, by which the measurement beam paths in the measuring head coordinate system are transformed into the measurement object coordinate system in such a way that the points of incidence measured in the measurement object coordinate system are located on the measurement beam paths transformed into the measurement object coordinate system. A conditional equation can thus be set up for each point of incidence using the point-straight line distance. Solving the system of equations resulting herefrom for a sufficient number of points of incidence using relevant known mathematics yields the sought-after coordinate transformation. In the simplest case, three points of incidence and, in many cases, four points of incidence will be sufficient for this purpose. In practice, care will be taken to use more than the minimum number of points of incidence to determine the parameters sought, since the accuracy of the determination increases with each additional point of incidence. Of course, in a system that is then overdetermined, a closed analytical solution will no longer be sought after; instead, use will be made of the relevant mathematical procedures for the optimal solution of such systems of equations.

In the concrete implementation of the determination of the unknown parameters, which are required in this case to carry out method step D, the procedure is advantageously such that the unknown parameters are initially only estimated. With the aid of these estimated parameters, the measurement beam paths present in the measuring head coordinate system are transformed into the measurement object coordinate system and their distances to the points of incidence measured in this coordinate system are determined there. From this, an error function is determined, e.g., by adding the distance squares. Using one of the known numerical methods for minimizing error functions, the parameters are now varied in such a way that the value of the error function is minimized. It was found that, as a result of this minimization, very good values are obtained for the sought-after parameters, which values are very well suited to the coordinate transformation between the two coordinate systems.

However, other methods which determine the described coordinate transformation or the associated parameters are also conceivable. In any case, however, the ascertained coordinate transformation provides the mapping required in method step D between the coordinates in the measurement object model and the coordinates in the measuring head model with the aid of the given structures in the first and second model and their spatial relation to one another.

A plurality of measuring heads or a plurality of measurement beams are not necessarily required for the procedure described here. Instead, in addition to the points of incidence of one or more measurement beams, the points of incidence of one or more auxiliary beams can additionally be used as the first structure in the measurement object model. As long as the beam paths of the auxiliary beams are spatially related to spatial structures in the measuring head model, in particular to the measurement beam or beams themselves—as described above for the plurality of measurement beams—these auxiliary beams can also be used instead of the measurement beams described above, and the specified spatial structures in the measuring head model or the auxiliary beams themselves can be used as a second structure in the measuring head model since a spatial relationship is established between the first structure in the measurement object model and the second structure in the measuring head model via the respective beam paths.

In principle, as described, the scope of the invention includes the use of points of incidence from one or more measurement beams and/or points of incidence from one or more auxiliary beams when using points of incidence on the measurement surface:

Thus, the scope of the invention includes the use of an auxiliary beam from an auxiliary beam source, the beam path of said auxiliary beam being coaxial with the measurement beam, at least in the region of the measurement object, so that the auxiliary beam is incident at the same location on the measurement surface as the measurement beam. It is true that in a multiplicity of interferometric measurements, a laser beam is used as a measurement beam with a wavelength in the visible range, which can be captured in an uncomplicated manner using typical image recording units. However, the scope of the invention also includes the use of an auxiliary beam generated by an additional auxiliary beam source for the purposes of determining the beam path:

The use of a measurement beam which cannot be detected, or which can only be detected with insufficient accuracy, by conventional image recording units is desirable for some applications of interferometric measurements. In particular, vibrometers which use laser beams in the infrared range, in particular at a wavelength of 1550 nm, are known.

A disadvantage here is that the user has no or only inadequate visual control over the respective applied measurement point and an automated finding of a point of incidence is only possible with additional technical effort. Therefore, an additional auxiliary beam from an auxiliary beam source is used in an advantageous embodiment of the method according to the invention. It is coupled into the beam path of the measurement beam in such a way that the auxiliary beam is incident at the same location of the measurement object as the measurement beam.

As described, the scope of the invention also includes the use of one or more auxiliary beams whose beam path is in specified fashion spatially related to the measurement beam and whose beam path is not identical to the beam path of the measurement beam, at least in the region of the measurement object. On account of the spatial relationship between the auxiliary beams and the measurement beam, which, according to method step C, is spatially related to the at least one measuring head element, there is of course a spatial relationship between the auxiliary beams and the at least one measuring head element. Then, the same procedure as before can be used, with one, more or all of the measurement beams described above being replaced by auxiliary beams. In this case, too, a mapping between coordinates in the measurement object model and coordinates in the measuring head model is created in method step D with the aid of a first structure in the measurement object model, namely the points of incidence of auxiliary and/or measurement beams, and a second structure in the measuring head model, namely here the measuring head elements, which themselves are spatially related to the auxiliary and/or measurement beams. Likewise, as described above, the auxiliary beams themselves can be used as the first structure and consequently represent the second structure used in the measuring head model.

In order to carry out a mapping according to the advantageous embodiment D3 of method step D, preferably at least three, more preferably at least four beams are used, which are incident at three or four or more spatially different points of incidence on the measurement object. Furthermore, the beam direction and the beam position, i.e., at least one location on each of the beams in the measuring head model and at least one direction vector or at least two locations on each of the two beams, are specified for these three, four or more beams in the measuring head model. In this advantageous embodiment, the mapping according to method step D is carried out by determining the spatial coordinates of the at least three points of incidence of the beams in the measurement object model (first structure) and the specified directions and positions of the beams in the measuring head model (second structure). It is advantageous here that the beams do not run parallel to one another.

Here, the scope of the invention includes the exclusive use of auxiliary beams. In the same way, a plurality of auxiliary beams can be combined with a single measurement beam from a single measuring head. Likewise, a plurality of measuring heads with a plurality of measurement beams can be used in a specified arrangement with respect to one another, as described above, and consequently use can be made of measurement beam points of incidence only. The scope of the invention likewise includes the use of a combination of the points of incidence of the measurement and auxiliary beams.

In method step E, the measurement beam path is determined by carrying out at least two of the aforementioned steps Ei, Eii and Eiii.

The measurement beam path is advantageously determined in the measurement object model, and hence in a coordinate system of the measurement object model. In method step E, therefore, the measurement beam path is preferably determined in a coordinate system of the measurement object model. The scope of the invention also includes firstly determining the measurement beam path in the measuring head model in method step E. Consequently, this case requires application of the mapping created in method step D (in particular coordinate transformation) between the measuring head model and the measurement object model. Therefore, the scope of the invention also includes carrying out method step D after method step E.

According to method step Ei, the coordinates of at least one location are determined, which is located on the optical axis defined by the measurement beam or which is in specified fashion spatially related thereto. The determination is implemented using the measuring head model.

As described above, the measuring head model can facilitate the determination of the coordinates of such a location in the measuring head model. By way of example, this is the case if the measuring head model comprises a measurement beam exit opening or a structure which is spatially related to the measurement beam exit opening and the spatial relationship is specified. If the position of the exit of the measurement beam from the measuring head is known, a location on the measurement beam in the measuring head model is consequently also known. As an alternative or in addition thereto, it is possible to specify the coordinates of a location in the measuring head model which has a specified spatial relationship to the optical axis of the measurement beam. By way of example, if the measuring head is rotatably mounted about a point of rotation, this point of rotation is typically at a fixed distance from the closest point on the optical axis of the measurement beam. The coordinates of the point of rotation are therefore also suitable for method step Ei, regardless of the actual rotational position of the measuring head relative to the point of rotation. Further examples of such a specified relationship have been given in the preceding table.

These embodiments of the method step Ei are summarized in the advantageous embodiment Ei1.

As described above, use can likewise be made of a predefined model, with at least one location on the optical axis defined by the measurement beam or in specified fashion spatially related thereto being contained and identified as such in the specified mode. As described above, the specified model can be assigned to the measurement object model in various ways in method step D such that the coordinates of the aforementioned location in the measurement object model are determinable in this case, too.

This advantageous embodiment of the method step Ei is summarized in the method step Ei2.

What is essential is that, by the mapping according to method step D, the spatial coordinates in the measuring head model can be transformed into spatial coordinates of the measurement object model.

According to method step Eii, the direction vector specified by the measurement beam propagation direction is determined on the basis of the measuring head model. In this method step, a location on the optical axis of the measurement beam or in specified fashion spatially related thereto is therefore not necessarily known. By contrast, the direction vector of the measurement beam propagation direction is determined.

In an advantageous embodiment Eii1 of method step Eii, a measuring head model based on a plurality of spatially resolved images is used for this purpose, as described above. By way of example, if it is known that the measuring head has an elongate extent, the direction of the measuring head in the measuring head model can be determined using algorithms known per se, in particular using alignment algorithms as described above in conjunction with method step C. In particular, it is advantageous to use algorithms known per se to determine an envelope for certain elements in the measuring head model, in particular an envelope which, as described above, schematically corresponds to the geometric structure of the measuring head. By way of example, if the measuring head has a substantially cylindrical shape, a cylinder is preferably aligned in the measuring head model with the measuring head in the measuring head model. In this case, the cylinder represents a very simple alignment model of the measuring head. The cylinder axis then represents the direction vector—but not necessarily the spatial position—of the measurement beam, provided the measurement beam is aligned parallel to the cylinder axis of the substantially cylindrical housing of the measuring head. Approximation algorithms can be specified accordingly for other shapes of measuring heads.

As an alternative or in addition thereto, the orientation of a surface of the measuring head can be used to determine the measurement beam propagation direction, provided that the spatial relationship between the surface, in particular a surface normal of this surface, and the measurement beam propagation direction is known. By way of example, if the measuring head has a flat surface in which the exit opening is situated, then algorithms for finding structures, known per se, can be used to find this surface in the measuring head model on the basis of predefined features and determine the orientation thereof in the measuring head model. Furthermore, in this advantageous embodiment, the orientation of the measurement beam relative to the corresponding surface of the measuring head is also specified. Typically, the measurement beam emerges perpendicular to a surface surrounding the exit opening. Knowing the orientation of the above-described surface and the orientation of the measurement beam in relation to this surface thus also allows determination of the direction vector of the measurement beam in the advantageous embodiment described.

In a further advantageous embodiment, a specified measuring head model, for example a CAD model or FE model, is used as the alignment model in order to align the orientation of the alignment model with the measuring head model using algorithms known per se. Furthermore, the orientation of the measurement beam is specified in the alignment model, and so the orientation of the measurement beam in the measuring head model is also determined as a result.

Here, too, the assignment made in method step B determines the direction vector, specified by the measurement beam propagation direction, in the measurement object model.

The above-described advantageous embodiments are combined in method step Eii1. What is essential is that, in combination with method step D, the direction vector of the measurement beam specified by the measurement beam propagation direction is determined in the measurement object model.

In a further advantageous embodiment, a plurality of measuring heads with a plurality of measurement beams are used, as described above. In this preferred embodiment, referred to as method step Eii2, the measurement beam propagation direction of the measurement beam is, in method step EU, determined for each measuring head on the basis of the measuring head model and transformed into a measurement beam propagation direction in the measurement object model by method step D.

In a further preferred embodiment as method step Eii3, the measurement beam propagation direction is determined in method step Ei1 on the basis of measurement data from at least one direction detector. As described above, the measuring head is arranged on a holding apparatus in a preferred embodiment, with the position of the measuring head relative to the holding apparatus being alterable. The position of the measuring head relative to the holding apparatus and/or a change in position relative to the holding apparatus can be detected by the position detector. In this case, the measuring head model comprises at least one structure which defines the position and orientation of the holding apparatus in the measuring head model. The measurement beam propagation direction of the measurement beam of the measuring head relative to the aforementioned structure of the holding apparatus is determined by the measurement data of the position detector and a predetermined assignment of measurement data to spatial positioning and/or a change in position of the measuring head with respect to the holding apparatus. As described above, the measurement beam propagation direction is then transformed from the measuring head model into a measurement beam propagation direction in the measurement object model on the basis of method step D.

In method step Eiii, the coordinates of the measurement beam point of incidence of the measurement beam and/or at least one auxiliary beam point of incidence of an auxiliary beam on the measurement object which is in specified fashion spatially related to the measurement beam is determined on the basis of at least one spatially resolved image which comprises the measurement beam point of incidence and/or the at least one auxiliary beam point of incidence on the measurement object.

The aforementioned at least one spatially resolved image can be captured in method step A if the measurement beam is switched on while the associated spatially resolved measurement object images are being recorded. This makes it possible, within the scope of method step B, to directly assign coordinates in the three-dimensional measurement object model to the point of incidence of the measurement beam.

Alternatively, the scope of the invention also includes a separate capture of the spatially resolved image, particularly preferably by a separate image recording unit.

The determination of coordinates of a beam point of incidence on the basis of at least one spatially resolved image which comprises this point of incidence is preferably carried out as described below:

The determination of relative position and orientation of a three-dimensional model in a spatially resolved image is known from the prior art, for example from: DOI: 10.1109/ICCV.2017.23. The relative position and orientation, which are known in that case, can be used to determine for each picture element of the associated spatially resolved image whether it represents a part of the surface of the three-dimensional model. Should it represent a part of the surface of the three-dimensional model, the closest known 3D coordinates of the surface of the three-dimensional model can be determined and the 3D coordinates of the part of the surface that is represented in the respective picture element of the spatially resolved image can be determined by suitable interpolation. In any case, determining the relative position and orientation of the three-dimensional measurement object model in a spatially resolved image then also allows the assignment of the associated 3D coordinates in the three-dimensional measurement object model to each location, in particular to each picture element of the spatially resolved image.

Typically, digital cameras, in particular cameras with a CCD or CMOS image sensor as described above, are used as image recording unit for recording the spatially resolved images, which have a multiplicity of image pixels. In the advantageous embodiment described above, spatial coordinates can be assigned to each image pixel of a spatially resolved image; in particular, spatial coordinates on the measurement surface in the three-dimensional model can be assigned to each image pixel showing the measurement surface.

To identify/localize the beam point of incidence in the spatially resolved image, it is advantageous to temporarily darken the image (in particular by closing a shutter of a camera of the image recording unit and/or by shortening the exposure time) such that it is preferably substantially only the beam point of incidence that is captured by the camera and, in particular, overexposure of the camera image by the measurement beam is avoided. The picture element coordinates of the beam point of incidence are preferably determined by suitable averaging of picture element coordinates with brightness levels above a certain threshold.

This method is also used in order, as described above, in particular in method step D when using a plurality of beam points of incidence of measurement and/or auxiliary beams, to determine the spatial coordinates of the points of incidence in the measurement object model. In this case, it may be advantageous to irradiate only one point sequentially in order to achieve a unique assignment between the point of incidence and the associated beam or associated beam source. The scope of the invention also includes other assignment methods, such as modulation of the beams, a differentiation of the beams in terms of color, size and/or shape of the point of incidence or other distinguishing features that are determinable by an image recording unit.

By the method according to the invention, an interferometric measurement is preferably carried out on the measurement object, in particular a measurement to ascertain vibration data, and the interferometric measurement is particularly preferably evaluated taking into account the measurement beam path.

As described above, the measurement apparatus according to the invention is preferably embodied as a vibrometer for carrying out a vibration measurement by the measurement beam.

In an advantageous embodiment, the measurement apparatus is consequently embodied as an interferometric measurement apparatus. In particular, the measurement beam used for the interferometric measurement is split into at least one measurement beam and at least one reference beam, preferably by a beam splitter.

The respective measurement beam is directed at a measurement point on the measurement object, and the measurement beam reflected and/or scattered by the measurement object passes along the beam path of the measurement apparatus again in order to be superimposed with the reference beam to form an optical interference. To that end, the measurement apparatus preferably comprises at least one detector in order to detect the interference signal. The desired measurement data, in particular vibration data and/or a speed of the movement of the surface of the object at the measurement point, can be determined from the interference signal. The aforementioned evaluation unit is preferably used to this end. The basic structure of the measurement apparatus can be embodied, in a manner known per se, like an interferometer, in particular a vibrometer as described above, preferably a heterodyne vibrometer. Vibrometers are known from the prior art, in particular from https://de.wikipedia.org/wiki/Vibrometer and DE 10 2007 010 389.

In the above-described advantageous embodiments, in which one or more auxiliary beams are used, it is advantageous to use laser beams generated by one or more laser sources as auxiliary beams.

Likewise, the scope of the invention includes the use of other beam sources for generating auxiliary beams, in particular also light beams from LEDs or other light sources that are designed, for example, as position lasers, line lasers, crosshair lasers, line projectors, crosshair projectors or other pattern generators with an imaging unit, etc.

The measuring head of the apparatus represents an element of the measurement apparatus from which the measurement beam emerges. The scope of the invention includes the entire measurement apparatus being integrated in the measuring head; in particular, the measuring head of a preferred embodiment comprises the radiation source for the original beam, in particular a laser, optical means for forming an interferometer, preferably with a measurement and a reference beam, in particular a Mach-Zehnder interferometer, and the at least one detector and the evaluation unit. Likewise, the scope of the invention includes the measuring head comprising only a subset of the elements of the measurement apparatus; in particular, the evaluation unit can be arranged outside the measuring head. The beam source can likewise be arranged outside the measuring head. In this case, the measurement apparatus preferably comprises at least one light guide for guiding the original beam from the radiation source to the measuring head. The interferometer can likewise be arranged outside the measuring head. In this case, the interferometer is preferably connected to the measuring head by at least one light guide in order to guide the measurement beam to the measuring head and to guide the measurement beam reflected and/or scattered on the measurement object, which measurement beam re-enters the measuring head, to the interferometer.

The evaluation unit preferably comprises electronic components for data processing, in particular a processor and a data memory. The evaluation unit is preferably embodied as a computer unit. The computer unit can be embodied as a component, known per se, for signal evaluation and can also comprise an FPGA decoder, in particular. The computer unit can likewise comprise one or more data processing elements, in particular electronic components, such as one or more computers, decoders, memory components or further components.

### BRIEF DESCRIPTION OF THE DRAWINGS

Further preferred features and advantageous embodiments are described below with reference to exemplary embodiments and figures. In this case:

FIG. 1 shows an embodiment of a measuring head and the associated alignment model;

FIG. 2 shows a first exemplary embodiment of a measurement apparatus according to the invention with one measuring head and two image recording units;

FIG. 3 shows a second exemplary embodiment of a measurement apparatus according to the invention with four displaceable measuring heads;

FIG. 4 shows the second exemplary embodiment to illustrate the use of a bridging object;

FIG. 5 shows a third exemplary embodiment of a measurement apparatus according to the invention with optical markers;

FIG. 6 shows a fourth exemplary embodiment of a measurement apparatus according to the invention with four pivotable measuring heads;

FIG. 7 shows exemplary embodiments of image recording units;

FIG. 8 shows a fourth exemplary embodiment of a measurement apparatus according to the invention; and

FIG. 9 shows views of the measurement object and a spatially resolved image for explaining the determination of the 3D coordinates for a picture element of the spatially resolved image.

### DETAILED DESCRIPTION

The figures show schematic representations that are not true to scale. In the figures, the same reference signs denote elements that are the same or have the same effect.

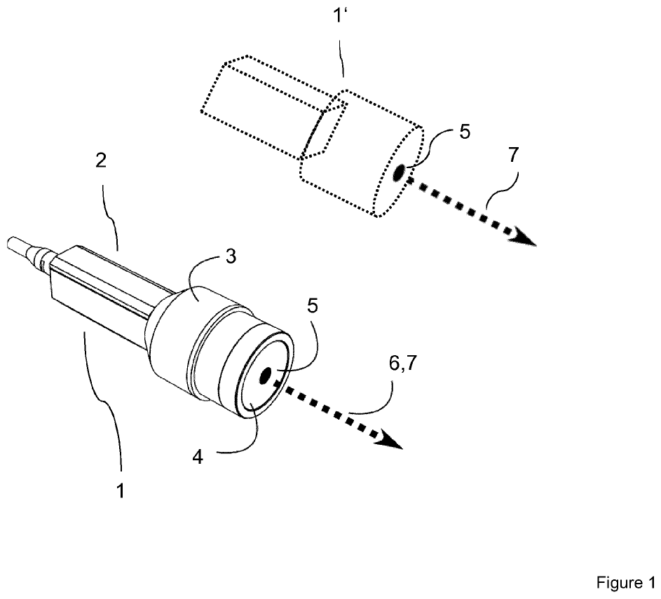

FIG. 1 shows a measuring head for a measurement apparatus according to the invention. The measuring head is embodied as a measuring head of a vibrometer. The vibrometer comprises a housing with an approximately cuboid back region and an approximately cylindrical front region.

In the present case, the components of the vibrometer are arranged within the housing: The vibrometer comprises a beam source embodied as a laser for generating a laser beam as a measurement beam. The measurement beam emerges from the measuring head 1 at a laser exit point 5 in a laser beam exit opening 4. Consequently, the measurement beam 6 has the measurement beam propagation direction 7 shown using dashed lines.

The measurement beam propagation direction 7 lies on the optical axis of the approximately cylindrical front part 3 of the measuring head.

The measurement beam 6 impinges on a measurement point on the measurement surface of a measurement article of the measurement object. The partially reflected and/or scattered measurement beam re-enters the measuring head 1 via the laser beam exit opening 4. The measuring head 1 embodied as a vibrometer is consequently embodied as an interferometric measurement apparatus and comprises an interferometric structure in the present case such that the laser beam generated by the laser is divided into the aforementioned measurement beam and a reference beam. The measurement apparatus furthermore comprises at least one detector and is embodied such that the aforementioned reflected and/or scattered measurement beam is superimposed with the reference beam on the detector in order to form optical interference. The detector is preferably a balanced detector consisting of two individual detectors for the two interferometer outputs that are correspondingly in a differential-type connection. The measurement signals of the detector are guided to an evaluation unit by a signal line at the back end of the cylindrical part 2 of the measuring head. The evaluation unit (not shown) comprises a computer unit which is embodied in a manner known per se, comprising a processor and a memory unit, in order to determine vibration data from the measurement data of the detector. To this end, the computer unit additionally comprises an FPGA decoder in the present case.

As described above, in method step C of the method according to the invention, provision is made of a measuring head model which comprises at least one measuring head element which is in specified fashion related to the measurement beam.

In one exemplary embodiment of the method according to the invention, the measuring head model comprises the laser beam exit opening 4, which is designed as an annulus. Furthermore, the information is specified that the laser exit point 5 is located centrally in the laser beam exit opening 4. In this exemplary embodiment, the coordinates of a location on the optical axis defined by the measurement beam in the measuring head model can consequently be determined in the measuring head model by determining the center point of the laser beam exit opening 4 (method step Ei).

An alternative exemplary embodiment specifies that the measurement beam propagation direction 7 of the measurement beam 6 is perpendicular to the laser beam exit opening 4, which has a planar embodiment. In this exemplary embodiment, the measurement beam propagation direction in the measuring head model can consequently be determined in a method step Eii.

In a further alternative exemplary embodiment, the line model of the measuring head 1 shown in FIG. 1 is specified as an alignment model 1′, as shown in FIG. 1 by the dashed objects: Geometric data of a cuboid and a cylinder and the size and spatial relationship of cuboid and cylinder to one another are made available as the abstract alignment model 1′. Furthermore, the location of the laser exit point 5 is specified in the alignment model. In a further exemplary embodiment, the measurement beam propagation direction 7 is alternatively or additionally specified in the alignment model 1′.

In this exemplary embodiment, a plurality of spatially resolved images of the measuring head are recorded using an image recording unit in method step C and, as described above, a three-dimensional model of the measuring head is created in a pattern projection method using photogrammetry, according to method step C1 and method steps Ci and Cii described above. Furthermore, the alignment model is used to determine the location of the laser exit point 5 in the measuring head model. Consequently, the above-described method steps C1 and C3 are carried out. The alignment between the specified measuring head model and the measuring head model created on the basis of the plurality of spatially resolved images from different perspectives is carried out as described above for method step C3 as a preferred embodiment using the two sequential steps described there.

In a modification of the aforementioned exemplary embodiment, the information that the measurement beam propagation direction runs along the cylinder axis of the specified cylinder is specified as additional information to the alignment model 1′. In this modification of the exemplary embodiment, a model of the measuring head is consequently also created in method step C, as described above, by the plurality of spatially resolved measurement object images from different perspectives. There is also an alignment with the abstract model, which comprises the aforementioned cuboid and the cylinder. Method steps C1 and C3 are consequently also carried out and there is an alignment as described above, the measurement beam propagation direction in the measuring head model being determined hereby in the present case.

After the alignment has been carried out, the measurement beam propagation direction 7 is known in the coordinate system of the measuring head model, said measurement beam propagation direction running along the cylinder axis of the abstract alignment model.

In order to fully carry out the above-described method steps Ei and Eii, it is necessary to map the coordinates of the measuring head model to coordinates of a measurement object model such that the data mentioned are also available in the coordinate system of the measuring head model. This is described in more detail below on the basis of exemplary embodiments of the method according to the invention and the measurement apparatus according to the invention.

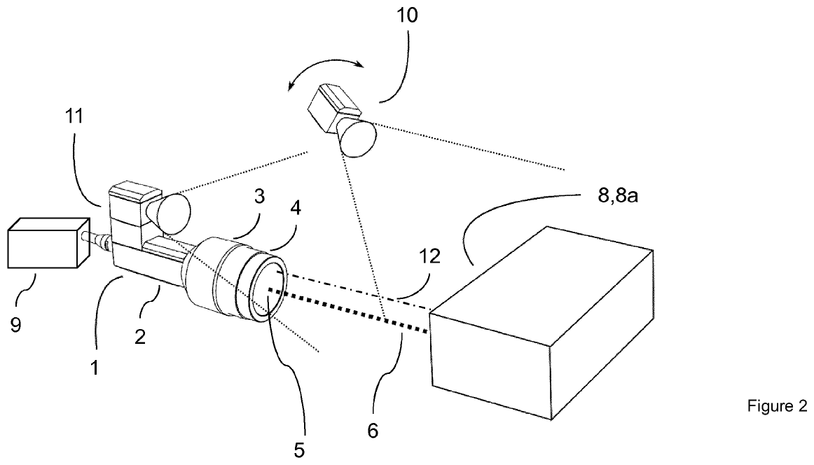

FIG. 2 schematically illustrates a first exemplary embodiment of a measurement apparatus according to the invention. The measurement apparatus comprises a measuring head 1 which is embodied as per the description of FIG. 1. The measurement apparatus is used to carry out a vibration measurement on a measurement object 8. The measurement object 8 comprises a measurement article 8a shown schematically as a cuboid.

As described above, the measuring head 1 comprises a laser as a beam source for generating a laser beam as original beam, a beam splitter for splitting the original beam into a measurement beam 6 and a reference beam, and a detector for detecting an interferometric measurement signal on the basis of the measurement beam 6 reflected and/or scattered on the measurement object 8, which is superimposed with the reference beam on a detection surface of the detector. The measuring head 1 is connected to an evaluation unit 9 in order to determine the measurement signals of a detector, arranged in the measuring head 1, of the measurement apparatus for determining vibration data of the measurement article 8a at the point of incidence of the measurement beam 6.

As described in relation to FIG. 1, the evaluation unit 9 comprises a computer unit with processor and memory unit and is embodied to determine the beam path of the measurement beam 6, as described below using a first exemplary embodiment of the method according to the invention.

The measurement apparatus furthermore comprises a first image recording unit 10 and a second image recording unit 11. Both image recording units are embodied as CCD cameras for recording spatially resolved images. The first image recording unit 10 is movable relative to the measurement object 8 and the measuring head 1. The second image recording unit 11 is fixedly arranged on the measuring head 1.

In a first exemplary embodiment of a method according to the invention, a plurality of spatially resolved images of the measurement article 8a are recorded in a method step A by the first image recording unit 10. To this end, a user moves the movable first image recording unit 10 around the measurement article 8a, while a multiplicity of spatially resolved images are recorded automatically.

The first image recording unit 10 is embodied to carry out a stripe projection and therefore has a camera for capturing spatially resolved images and a projection unit for projecting stripe patterns. The first image recording unit 10 is connected to the evaluation unit 9 by a cable or, alternatively, in wireless fashion. The evaluation unit 9 thus also carries out the storage and processing of the data of the first image recording unit 10 and of the second image recording unit 11.

As described above, the first image recording unit 10 generates patterns, for example according to the principle of stripe projection, during the recording of the plurality of spatially resolved images such that, in manner known per se, a three-dimensional model is created photogrammetrically by the evaluation unit 9 in a method step B, said model at least comprising the surface of the measurement article 8a facing the measuring head 1. The three-dimensional model has a polygon mesh of triangles, which reproduces the geometric shape of this region. Alternatively, the first image recording unit 10 is embodied as a commercially available camera or a combination of an illumination unit and one or more cameras. Both black-and-white and color cameras can be used. Particularly preferably, in addition to the information required to determine the geometry of the measurement surface, the image recording unit also records information items relating to the texture and/or color of the surface, particularly preferably by comprising a color camera, for example. The recording of texture and/or color information items and their spatial association with the recorded images or the topographical 3D model of the object is particularly advantageous because, as described above, this allows the different recorded images to be associated with one another much better and the location of the recording of the respective camera image can also be assigned much more precisely relative to the 3D model.

In a method step C, a measuring head model is provided which comprises at least one measuring head element which is in specified fashion related to the measurement beam 6.

In the present exemplary embodiment, method step C is embodied as a combination of method steps C1 and C3, as described above. According to the description of FIG. 1, an alignment model 1′ of the measuring head 1 is made available, which is embodied as a polygon mesh in the present case and in which the laser exit point 5 is labeled. In a method step Ci, a plurality of spatially resolved measuring head images are recorded by the first image recording unit 10, said measuring head images comprising at least the laser beam exit opening 4 as the measuring head element. The plurality of spatially resolved images of the measuring head are recorded from different perspectives.

The measuring head model is created in a method step Cii by the plurality of spatially resolved measuring head images. Then, as already described for FIG. 1, an alignment is implemented with the specified measuring head model, and so the position of the laser exit point 5 is known in the coordinate system of the measuring head model.

In a method step D, a mapping between coordinates in the three-dimensional measurement object model and coordinates in the measuring head model is created with the aid of a first structure in the measuring head model and a second structure in the measuring head model and on the basis of a spatial relationship between the first and second structure.

In the present first exemplary embodiment of a method according to the invention, method step D is designed as method step D1 as described above. Consequently, the first structure is identical to the second structure. Furthermore, the measurement object model and the measuring head model are created as a common model.

In this exemplary embodiment, the user thus also records spatially resolved images of the space between the measurement object 8 and the measuring head 1 by the first image recording unit 10. Consequently, method step Ci is integrated into method step A. As a result, there consequently are at least partially overlapping spatially resolved images proceeding from the measurement object 8 to the measuring head 1. Consequently, a bridge is created between measurement object 8 and measuring head 1 by the plurality of at least partially overlapping spatially resolved images. When creating the common model of measuring head and measurement object by the above-described photogrammetric methods known per se, a model consequently arises in which measuring head 1 and measurement object 8 are located in a common coordinate system. In this exemplary embodiment, the first and second structure are therefore any structure, since both models are created as a common model and consequently all structures are located both in the measuring head model and in the measurement object model. As an example, a structure in the space between measurement object 8 and measuring head 1 can be referred to as an identical first and second structure.

Since the measurement object model and the measuring head model are created as a common model, method step D has already been carried out, as described above, since a mapping between coordinates in the three-dimensional measurement object model and coordinates in the measuring head model has already been created using a first structure in the measurement object model and a second structure in the measuring head model and on the basis of a spatial relationship between the first and second structure.

In a method step E, the measurement beam path of the measurement beam 6 is determined in the present case by carrying out method steps Ei and Eiii:

As described above, an alignment model in which the laser exit point 5 is localized was provided. Therefore, the coordinates of the laser exit point 5 are known in the measurement object model.

A spatially resolved image of the measurement surface of the measurement object 8 is recorded by the second image recording unit 11, said image comprising the measurement point on the measurement surface impinged upon by the measurement beam 6.

The measurement point is localized in the spatially resolved image by the evaluation unit 9, in particular by darkening the camera image and specifying a threshold, as described above. Subsequently, spatial coordinates in the measurement object model are mapped to the point of incidence of the measurement beam 6, as described above.

The coordinates of the measurement beam point of incidence of the measurement beam on the measurement object have thus been determined in accordance with method step Eiii.

This determines the beam path of the measurement beam 6: The coordinates of the laser exit point 5 and of the point of incidence of the measurement beam 6 on the measurement article 8a are known in the coordinate system of the measuring head model. Consequently, the optical axis of the measurement beam 6 is defined by these two points. In particular, an angle of incidence of the measurement beam 6 on the measurement article 8a can be ascertained in a simple manner. By way of example, a surface orientation of the surface of the measurement article 8a in the region of the point of incidence of the measurement beam 6 can be ascertained in the measurement object model, and the angle of incidence of the measurement beam on the measurement article 8a can be determined using the previously determined optical axis of the measurement beam 6.

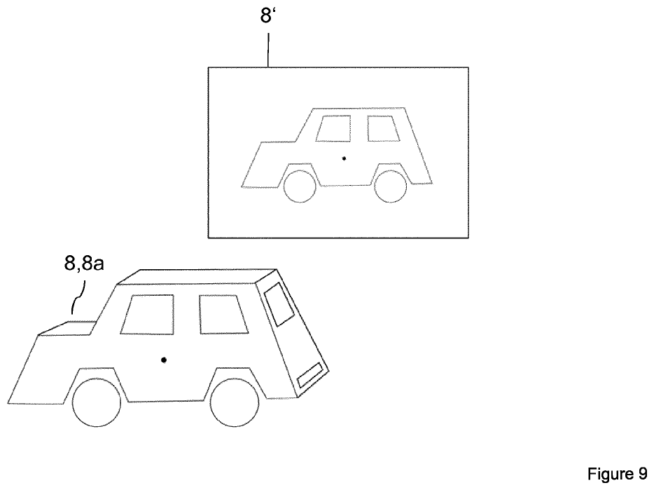

Alternatively, the spatially resolved image comprising the measurement point on the measurement surface impinged upon by the measurement beam 6 can also be captured by the first image recording unit 10 instead of the second image recording unit 11. As a result, it is possible, as described above, to determine the coordinates of the measurement beam point of incidence in the measurement object model, in particular as explained in more detail for FIG. 9.

In an alternative embodiment of the measurement apparatus according to the invention as per the first exemplary embodiment, the measuring head 1 additionally comprises an auxiliary beam source for emitting an auxiliary beam 12.

The auxiliary beam 12 runs parallel to, but at a distance from, the measurement beam 6 in a known direction.

In this exemplary embodiment, the information about the distance at which the auxiliary beam 12 runs relative to the measurement beam 6 is additionally specified in method step C.

Method step Ei is carried out analogously, since the position of the laser exit point 5 is additionally specified in the measuring head model, as described above.

In this exemplary embodiment, however, a spatially resolved image is recorded in method step Eiii, said image comprising the point of incidence of the auxiliary beam 12 on the measurement surface. A spatially resolved image is recorded by the second image recording unit 11, said image comprising the point of incidence of the auxiliary beam 12 on the measurement article 8a. As described above, the point of incidence of the auxiliary beam is localized in this spatially resolved image and coordinates are assigned to the point of incidence of the auxiliary beam in the measurement object model.

Since the auxiliary beam 12 and the measurement beam 6 have been specified as running in parallel and since the distance between the auxiliary beam and the measurement beam has been specified, the beam path of the measurement beam 6 can also be determined from these data.

In the following figures, further exemplary embodiments of measurement apparatuses according to the invention are shown, and further exemplary embodiments of the method according to the invention are described. These measurement apparatuses and methods correspond in a plurality of features to the measurement apparatus and the method according to the description of FIG. 1. To avoid repetition, the essential differences, in particular to the previously described exemplary embodiments of the measurement apparatus and the method, are discussed below:

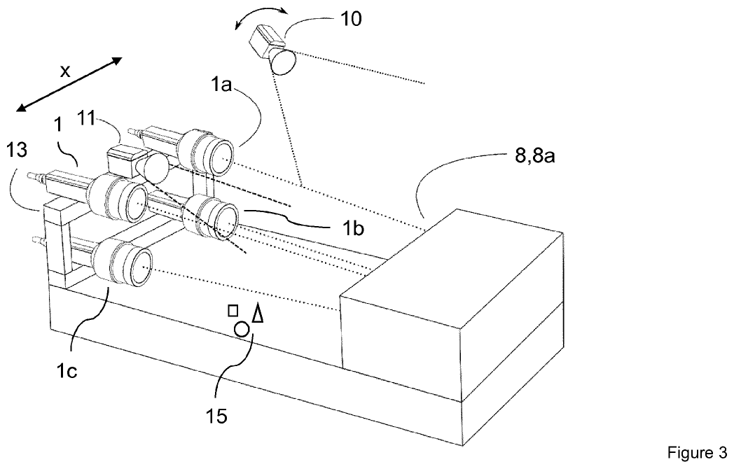

FIG. 3 shows a second exemplary embodiment of a measurement apparatus according to the invention.

It comprises a total of four measuring heads 1, 1a, 1b and 1c, which are arranged on a common holding apparatus 13. The measuring heads are all connected to the evaluation unit 9, which are not illustrated for the sake of improved clarity.

Before determining the beam path, the measuring heads are displaced on the holding apparatus 13 in the shown x-direction by the user in order to achieve a desired measurement configuration.

Thus, for example, four measurement points on the measurement article 8a can be impinged upon at the same time, in particular four measurement points at different locations.

In a second exemplary embodiment of the method according to the invention, the procedure is analogous to the first exemplary embodiment: A common model is created, which includes the measurement object model and the measuring head model for all measuring heads: By the movable first image recording unit 10, the user records a plurality of spatially resolved images from different perspectives, which comprise the measurement article 8a, all measuring heads 1, 1a, 1b and 1c and the space between measurement article 8a and at least one of the measuring heads.

After forming a three-dimensional measurement object model as described above, the measurement object model consequently also includes the measuring heads, and so the mapping according to method step D has already taken place as described above.

In this second exemplary embodiment, the measuring heads are identical in structure. For method step C, it is therefore only necessary, as described in the first exemplary embodiment, to specify a measuring head model in which the location of the laser exit point 5 is localized. This model can be used for all four measuring heads, and so the location of the respective laser exit point 5 in the measuring head model and hence also in the measurement object model is known for all four measuring heads.

Four spatially resolved images are recorded by the second image recording unit 11, each image respectively comprising a point of incidence of the measurement beam 6 of one of the measuring heads. To this end, only measuring head 1 is initially switched on such that the spatially resolved image only includes the point of incidence of the measurement beam 6 of the measuring head 1. Subsequently only measuring head 1a is switched on and these steps are carried out accordingly for all four measuring heads such that four spatially resolved images are present, each of which comprising the measurement beam point of incidence of one of the measuring heads.

As described above, the evaluation unit 9 is used to localize the measurement beam points of incidence and to assign spatial coordinates in the measurement object model to all four measurement beam points of incidence. To this end, the aforementioned four spatially resolved images are used and the spatial coordinates are determined, as described above, in the measurement object model.

Consequently, according to method step Ei, the spatial coordinates of the laser exit point 5 and, according to method step Eiii, the spatial coordinates of the point of incidence of the measurement beam are available for each measuring head. For each measuring head, the respective measurement beam path and the respective angle of incidence of the measurement beam on the surface of the measurement article 8a at the respective measurement point are determined on the basis of these data.

In a developed embodiment of the exemplary embodiment described above, the four spatially resolved images described above, which each comprise a point of incidence of the measurement beam 6 of one of the measuring heads, are not recorded using the image recording unit 11 but are recorded using the image recording unit 10 in method step A, during the recording of the spatially resolved images for creating the measurement object model. As described above, the points of incidence are each localized in the spatially resolved images and they are each assigned spatial coordinates in the measurement object model, in the present case as described for FIG. 9. Here, too, according to method step Ei, the spatial coordinates of the laser exit point 5 and, according to method step Eiii, the spatial coordinates of the point of incidence of the measurement beam are available for each measuring head, and the respective measurement beam path and the respective angle of incidence of the measurement beam on the surface of the measurement article 8a at the respective measurement point can be ascertained for each measuring head.

In an alternative embodiment of the first exemplary embodiment, the measurement apparatus additionally comprises a position detector for each of the measuring heads: As described above, the measuring heads can be moved in the x-direction by the user. The position detectors of each measuring head are likewise connected to the evaluation unit 9, and so the evaluation unit 9 determines the respective x-position for each measuring head on the basis of the measurement data of the respective position detector. The position detectors are thus advantageous in that, after one or more measuring heads have been positioned by way of a displacement by the user, there is no need for spatially resolved images of the measuring heads to be recorded again since the altered positioning can be taken into account by reading the measurement data from the position detectors.

In a further alternative embodiment, the measuring heads are not displaceable in the x-direction, as shown in FIG. 3, but can be rotated about two axes. Accordingly, the measurement apparatus in this alternative embodiment comprises two direction detectors as position detectors for each measuring head. Method step C accordingly specifies as information how the spatial coordinates of the laser exit point of the respective measuring head are determined relative to the holding apparatus on the basis of two angles of inclination of the measuring heads determined by the direction detectors.

In this modification of the exemplary embodiment, the measuring heads can thus be tilted in two spatial directions by the user. The measurement beam path is determined in the same way for each of the four measuring heads.

In a further modification of the exemplary embodiment, optical markers 15 are arranged in the floor region between the measurement object 8 and the measuring heads. The optical markers 15 are also captured by a spatially resolved image when carrying out method step A and/or Ci. This is advantageous if the intention is to change the position of the measurement object 8 or of the holding apparatus 13: If the user decides to change the position of only one of these objects and if the position of the other object remains unchanged relative to the optical markers, the user only needs to record a plurality of spatially resolved images which comprise the changed object and the optical markers 15 after changing the position. Then, a corrected common model can be created by the evaluation unit 9. By way of example, if the user displaces or rotates the measurement object 8 but leaves the holding apparatus 13 and the measuring heads unchanged, then only a plurality of spatially resolved images of the measurement object 8 in an altered position and of the optical marker 15 need to be recorded. The optical markers 15 represent the identical, common structure in the measurement object model and measuring head model, and so the corresponding assignment according to method step B is implemented by the evaluation unit 9.

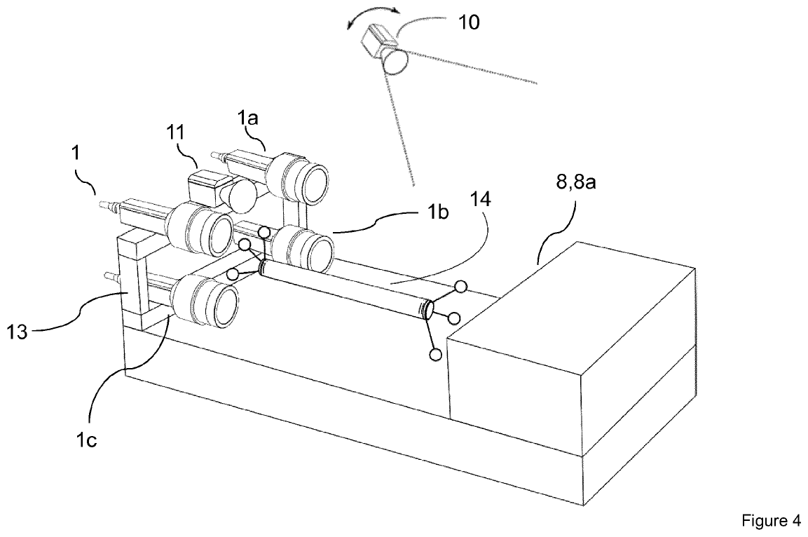

FIG. 4 once again shows the second embodiment of the measurement apparatus according to the invention in order to clarify a further exemplary embodiment of the method according to the invention with a method step D2:

The method is substantially the same as the second exemplary embodiment of a method according to the invention written for FIG. 3, but with modifications as follows:

In the third exemplary embodiment of a method according to the invention, the measurement object model and the measuring head model are created separately:

In method step A, a plurality of spatially resolved measuring head images are recorded; however, these only comprise the measurement object 8 and not the space between the measuring heads and not the measuring heads 1, 1a, 1b and 1c either.

In method step B, a three-dimensional measurement object model is created accordingly.

In method step C, the measuring heads 1, 1a, 1b and 1c are captured in a common model. The specification of alignment models and additional information items is also implemented in accordance with the second exemplary embodiment of the method according to the invention.

However, a rod is used as the bridging object 14 in the present third embodiment. The bridging object 14 is embodied as a metal rod, which has three spaced apart spheres of different colors at each end.

Images of the spheres of the bridging object 14 facing the measurement object 8 are also recorded when the plurality of spatially resolved images are recorded in accordance with method step A.

Correspondingly, when a plurality of spatially resolved images are recorded in method step Ci, the spheres facing the measuring heads are captured by these images.

The spheres which face the measurement object 8 thus form a first structure in the measurement object model and the spheres which face the measuring heads thus form a second structure in the measuring head model.

Additionally, the spatial relationship between the two structures is specified in this exemplary embodiment: In the present case, the length of the rod is specified, as is the spatial arrangement of the spheres at the respective end of the rod and hence also the spatial arrangement of all spheres relative to one another.

Consequently, in method step D, it is possible to perform a mapping between coordinates in the three-dimensional measurement object model and coordinates in the measuring head model with the aid of the first structure in the measurement object model and the second structure in the measuring head model and on the basis of the above-described spatial relationship between the first and second structure. In this exemplary embodiment, the use of the bridging object 14 and the specification of the above-described information items relating to the bridging object 14 are consequently needed. In return, the user need not also capture the space between the measurement object 8 and the measuring heads by spatially resolved images.

Subsequently, method step E can be carried out as described above.

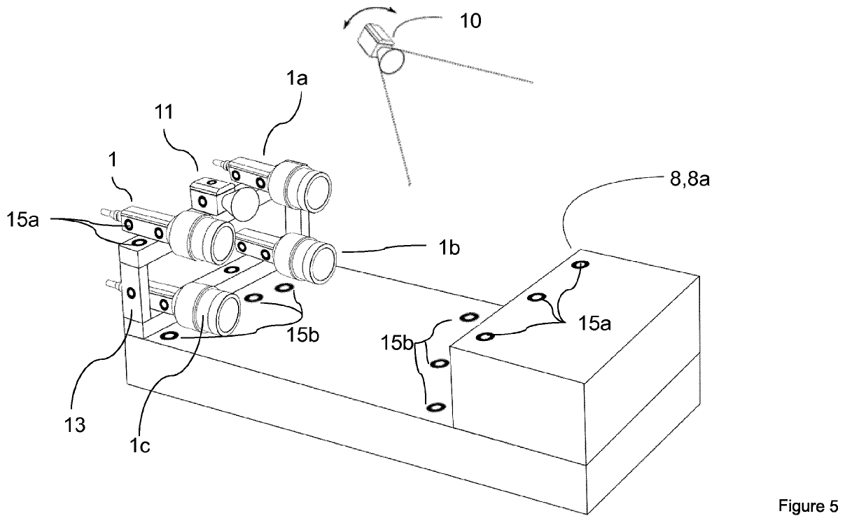

FIG. 5 once again illustrates the measurement apparatus according to the second exemplary embodiment in order to clarify a fourth exemplary embodiment of a method according to the invention, likewise with a method step D2: The fourth exemplary embodiment corresponds to the third exemplary embodiment of the method according to the description of FIG. 4, with the following differences:

A plurality of ring-shaped optical markers 15a are used as the bridging object. For reasons of improved clarity, only some of the ring-shaped optical markers on the measuring heads and on the holding apparatus are provided with reference sign 15a.

Thus, the information about the spatial distances between the markers 15a arranged on the measurement object and the markers 15a arranged on the holding apparatus is additionally specified in this fourth exemplary embodiment. These spatial distances can be measured by, e.g., the user, for example using a tape measure or a rule. It is therefore likewise not necessary for the space between the measurement object 8 and the holding apparatus 13 to be captured by spatially resolved images. The optical markers arranged on the measurement object 8 consequently represent a first structure in the measurement object model and the markers arranged on the holding apparatus and/or the measuring heads thus consequently represent a second structure in the measuring head model for carrying out method step D. The spatial relationship between the first and second structure is specified by the user on the basis of their measurements.

In a modification of the preceding exemplary embodiment, the markers 15a arranged on the measurement object 8 in FIG. 5 are instead arranged in the surroundings of the measurement object 8, for example on the floor in front of the measurement object (see marker 15b in front of the measurement object 8). Markers are likewise arranged in the surroundings of the holding apparatus, for example on the floor in front of the holding apparatus (see marker 15b in front of the holding apparatus 13).

The spatial relationship between the markers 15b on the measurement object and the markers 15b on the holding apparatus is specified, for example by the user who measures the respective distances between the markers with a tape measure. The measurement object model is captured in method step A in such a way that the markers 15b are also contained in front of the measurement article 8a. Accordingly, the measuring head model is captured in method step Ci in such a way that the markers 15b are also contained in front of the holding apparatus 13. The markers 15b in front of the measurement object thus represent the first structure and the markers 15b in front of the holding apparatus represent the second structure for method step D. This allows method step D to be carried out in analogous fashion.

This is advantageous in that the user only has to measure the distances between the markers 15b once. Subsequently, even after changing the position of the holding apparatus or the measurement object, it is only necessary to create a new measurement object or measuring head model, without the spatial relationship between the first and second structure having to be captured again.

In a further modification, markers 15a are additionally specified on the measuring heads 1, 1a, 1b, 1c, as is the information that the measurement beam path of each measuring head runs parallel to a connecting line of the two markers of this measuring head. Therefore, no alignment model needs to be used in this exemplary embodiment since the beam direction of each measurement beam in the measuring head model can be determined after a measuring head model which comprises the markers 15b in front of the holding apparatus 13 and the markers 15a on the measuring heads has been created.

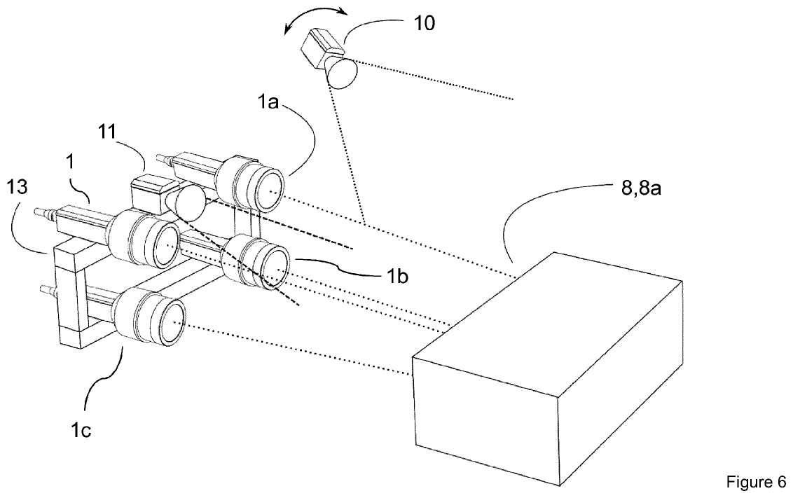

FIG. 6 shows a third exemplary embodiment of a measurement apparatus according to the invention in order to clarify a fifth exemplary embodiment of a method according to the invention with a method step D3:

The measurement apparatus is embodied largely in accordance with the measurement apparatus according to the second exemplary embodiment and the description for FIG. 3. The four measuring heads 1, 1a, 1b and 1c, which can be tilted about two axes by the user in the present case, are arranged on a holding apparatus 13. Accordingly, the measurement apparatus has two rotary position detectors for each measuring head in order to capture the tilt selected by the user for each measuring head.

For method step C, a measuring head model is specified which, on the basis of the tilt angles for each of the measuring heads, specifies the measurement beam propagation direction for each measuring head and the spatial coordinates of the laser exit point for each measuring head.

After the user has brought each of the measuring heads 1, 1a, 1b and 1c into a desired position by way of a rotation about the two axes, the evaluation unit 9 uses the rotary position detectors to detect the tilt angle of the measuring heads selected by the user. On the basis of the specified assignment of tilt angles to the spatial coordinates of the laser exit points and to the measurement beam propagation directions, the evaluation unit 9 determines the spatial coordinates of the laser exit point and of the measurement beam propagation direction in the measuring head model for each of the measuring heads.

In this exemplary embodiment, the user only captures a plurality of spatially resolved images of the measurement object 8 by the first image recording unit 10. From this, a three-dimensional measurement object model is created in method step B, as described above.

The spatial coordinates of the point of incidence of the associated measurement beam on the measurement article 8a in the measuring head model are determined according to the description of FIG. 3 by the second image recording unit 11, as described above.

Consequently, the spatial coordinates of the measurement beam points of incidence are known in the measurement object model. Furthermore, the position of the laser exit point and the measurement beam propagation direction in the measuring head model are known for each measuring head.

The mapping according to method step D takes place as described above for method step D3.

In a modification of the exemplary embodiment described above, a spatially resolved image of the point of incidence of the associated measurement beam impinged upon by the respective measurement beam can likewise be recorded for each measuring head by the image recording unit 10 during the recording of the spatially resolved images according to method step A. Here, too, according to the description of FIG. 9, the spatial coordinates of the point of incidence in the measurement object model are determined for each measuring head by the spatially resolved image which comprises the point of incidence impinged upon by the associated measurement beam.

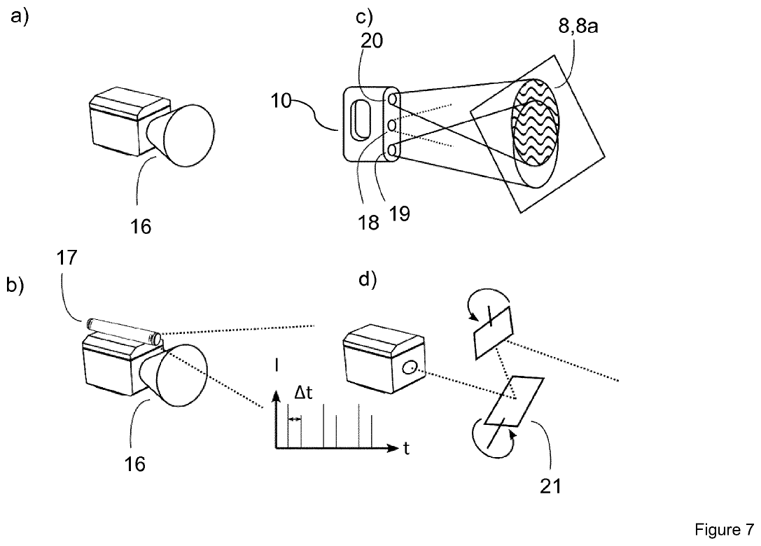

FIG. 7 schematically illustrates exemplary embodiments of image recording units for exemplary embodiments of the measurement apparatus according to the invention and for use in exemplary embodiments of the method according to the invention:

The image recording unit a) is embodied as a commercially available digital camera, known per se, with a lens 16. The image recording unit according to b) additionally has a range finder 17.

In an alternative embodiment, the element provided with reference sign 17 is embodied as an illumination unit for illuminating the measurement object with pulsed and/or modulated light. An evaluation unit evaluates the time of flight (in the case of pulsed light) and/or a phase shift (in the case of modulated light) between the light emitted by the illumination unit 17 and the light received by the digital camera in order to determine the distance in a manner known per se, in particular according to the “time-of-flight” method.

As a matter of principle, these two cameras can be used both as a movable image recording unit 10 and as a fixed image recording unit 11.

The image recording unit c) is particularly suitable as a movable image recording unit 10:

The image recording unit according to c) comprises a color camera 18, a black-and-white camera 19 and a stripe projection unit 20. A stripe pattern is projected onto the measurement object 8 and, in particular, the measurement article 8a by the stripe projection unit 20. A spatially resolved image is recorded by the black-and-white camera 19. Subsequently, the stripe projection unit 20 and the black-and-white camera 19 are switched off and a spatially resolved color image is recorded by the color camera 18. This process is repeated in quick succession. The user guides the movable image recording unit 10, which is designed as a hand-held appliance, around the measurement article 8a such that a plurality of spatially resolved images are recorded both by the black-and-white camera 19 and by the color camera 18. A three-dimensional model of the measurement object 8 can be created from the images of the black-and-white camera using the stripe projection method known per se. Moreover, the individual surfaces of the three-dimensional model, in particular surfaces of a polygon mesh of the three-dimensional model, can be assigned image components of the color images recorded by the color camera 18, and so it is not only a three-dimensional model that is present but, moreover, a color image of the associated surface for each polygon.

The image recording unit d) has only one beam which can be directed at points on the surface of the measurement object by two rotatable mirrors of a deflection unit 21 of the image recording unit d). The image recording unit d) is embodied as a time-of-flight unit: In a scanning method, the measurement beam of the image recording unit d) is directed at a multiplicity of locations on the object. A light pulse is emitted for each location and the time within which the light pulse reflected or scattered by the object arrives at the image recording unit d) again is measured. In a manner known per se, the distance to the object can be determined from the time difference between the emission of the light pulse and the return of the light pulse. A corresponding result can be achieved by light that is sinusoidally modulated rather than pulsed. The time difference between the emission of the modulated light and the return of the reflected/backscattered light is determined from the phase relationship between the emitted and the received modulated light in this case. A three-dimensional model of the object can be created from a comparison of the times required in each case for the plurality of measurement points. The image recording unit d) is therefore suitable for carrying out method steps A and B.

In this case, too, a spatially resolved image is initially recorded by the aforementioned scanning method without moving the image recording unit d) relative to the measurement object. The image recording unit d) is subsequently moved relative to the measurement object in order to record a further spatially resolved image from a different perspective, likewise by the scanning method. By repeating these processes, a plurality of spatially resolved images are recorded from different perspectives, according to method step A.

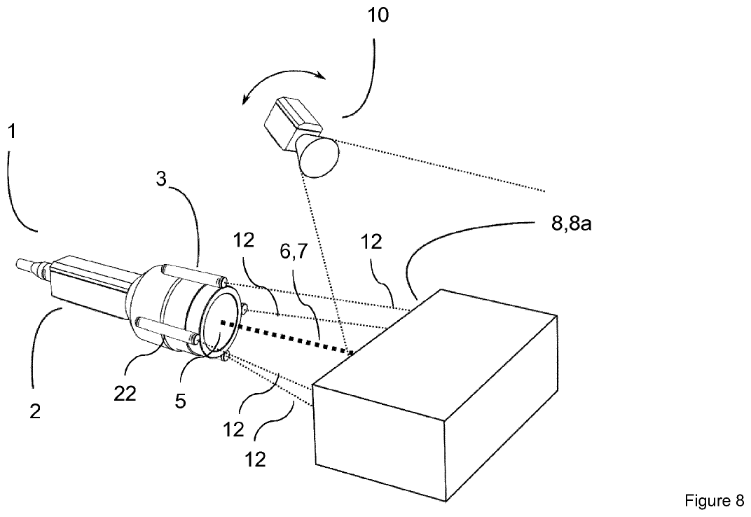

FIG. 8 illustrates a fourth exemplary embodiment of a measurement apparatus according to the invention. It largely corresponds to the first exemplary embodiment according to FIG. 2, but comprises four auxiliary beam sources 22, which each generate an auxiliary beam 12, instead of a second image recording unit arranged on the measuring head 1. The auxiliary beams 12 impinge on spatially different points on the measurement object 8a. A three-dimensional measurement object model is created according to method steps A and B to determine the beam path of the measurement beam 6, as described above. In method step C, a measuring head model is provided on the basis of CAD data, said model comprising the alignment of the auxiliary beam sources 22. The beam paths of the auxiliary beams 12 are consequently known in the measuring head model, in particular in relation to one or more measuring head elements of the measuring head 1. The spatially resolved images recorded by the image recording unit 10 also comprise at least one image which shows at least parts of the measurement article 8a while it is being impinged upon by the four auxiliary beams. Method step D is therefore carried out in accordance with the advantageous embodiment D3 described above, with the determination of the coordinates of the points of incidence of the auxiliary beams 12 in the measurement object model. The points of incidence of the four auxiliary beams 12 on the measurement object consequently define the first structure and the measuring head elements specified in the measuring head model, the spatial relationship of which measuring head elements to the beam paths of the auxiliary beams 12 is known, define the second structure.

Furthermore, the direction of propagation of the measurement beam 6 and the location of the laser exit point 5 are specified in the measuring head model. As a result of the above-described mapping according to method step D3, the beam path of the measurement beam 6 in the measurement object model can consequently also be determined in method step E.

In a modification of the exemplary embodiment described above, the spatial arrangement of the auxiliary beams 12 relative to the measurement beam 6 is specified as the measuring head model. The auxiliary beams 12 are not aligned parallel to one another, and so the beam path of the measurement beam 6, in particular the angle of incidence on the measurement article 8a, can be calculated on the basis of the coordinates of the points of incidence.

In the present exemplary embodiment, this is implemented by virtue of the fact that the associated points of incidence on the measurement object can be calculated for every possible position and orientation of the measuring head model, which substantially consists of light beams. The sum of the squares of the distance to the actually measured points of incidence is zero or minimal in the case of the correct assumed position and alignment of the measuring head model. The correct position and alignment of the measuring head model is now determined using a minimization algorithm, a gradient method in the simplest case. From the position and orientation of the measuring head model relative to the measurement object, the beam path of the measurement beam 6 in the measurement object model then arises in a simple manner in combination with the knowledge of the measurement beam path in the measuring head model.

FIG. 9 schematically shows a view of the measurement object 8—shown here as an automobile—with a laser beam point of incidence, labeled by a point, approximately in the center of the measurement article 8a. Above this, a spatially resolved image 8′, which was recorded with an image recording unit, is illustrated schematically. The image 8′ also comprises the laser beam point of incidence. As described above, by mapping coordinates of the measurement object model to the picture elements of image 8′ and by localizing the laser beam point of incidence in the image 8′, the laser beam point of incidence can be assigned a position in the measurement object model, in particular coordinates in the coordinate system of the measurement object model, in particular by virtue of the position of the laser beam point of incidence initially being localized in the camera image and then the points of the geometry model whose projection on the camera image is very close to the laser beam point of incidence in the camera image being sought after. By interpolating the 3D coordinates of these points of the geometry model, the 3D coordinates of the laser beam point of incidence can finally be determined.

### LIST OF REFERENCE SIGNS

1, 1a, 1b, 1c Measuring head
1′ Alignment model
2 Cuboid part of the measuring head
3 Cylindrical part of the measuring head
4 Laser beam exit opening
5 Laser exit point
6 Measurement beam
7 Measurement beam propagation direction
8 Measurement object
8a Measurement article
9 Evaluation unit
10 First image recording unit
11 Second image recording unit
12 Auxiliary beam
13 Holding apparatus
14 Bridging object
15, 15a, 15b Optical marker
16 Lens
17 Range finder
18 Color camera
19 Black-and-white camera
20 Stripe projection unit
21 Deflection unit
22 Auxiliary beam source

1. A method for determining a beam path of a measurement beam of an interferometric measurement apparatus, comprising the method steps of:
A. recording a plurality of spatially resolved measurement object images of at least one measurement surface of a measurement object from different perspectives;
B. creating a three-dimensional measurement object model which comprises at least the measurement surface of the measurement object by the plurality of spatially resolved images of the measurement surface;
C. providing a measuring head model which comprises at least one measuring head element which is related to the measurement beam (6) in a specified way;
D. creating a mapping between coordinates in the three-dimensional measurement object model and coordinates in the measuring head model with the aid of a first structure in the measurement object model and a second structure in the measuring head model and based on a spatial relationship between the first and second structure;
E. determining the measurement beam path by carrying out at least two of the following steps:
Ei. determining coordinates of at least one location, which is located on an optical axis defined by the measurement beam (6) or which is spatially related thereto, based on the measuring head model;
Eii. determining a direction vector specified by a measurement beam propagation direction (7) based on the measuring head model;
Eiii. determining coordinates of at least one of a measurement beam point of incidence of the measurement beam or of at least one auxiliary beam point of incidence of an auxiliary beam on the measurement object (8) which is spatially related to the measurement beam (6) based on at least one spatially resolved image which comprises at least one of the measurement beam point of incidence or the at least one auxiliary beam point of incidence on the measurement object (8).

2. The method as claimed in claim 1, wherein
the first structure is identical to the second structure, and the measurement object model and the measuring head model are created as a common model.

3. The method as claimed in claim 1, wherein
the first structure is at a distance from the second structure, and the first and second structure do not overlap.

4. The method as claimed in claim 3, further comprising using a bridging object (14) in method step D, said bridging object comprising the first structure in a first portion and the second structure in a second portion and the spatial relationship between the first and second structure is specified by the bridging object (14).

5. The method as claimed in claim 1, wherein the first structure has at least one first optical marker and the second structure has at least one second optical marker and a spatial relationship between the first and second optical marker is specified.

6. The method as claimed in claim 1, wherein the method is carried out for a plurality of measuring heads by a common measurement object model.

7. The method as claimed in claim 6, wherein the plurality of measuring heads impinge on spatially different measurement beam points of incidence on the measurement object (8), method step Eiii is carried out for each said measurement beam point of incidence, and the spatially different measurement beam points of incidence are used as the first structure.

8. The method as claimed in claim 7, wherein the method steps Ei and Eii are carried out for each said measuring head, and the spatial relationship between the first and second structure is ascertained from coordinates and a direction vector determined therefrom and from coordinates of the measurement beam points of incidence.

9. The method as claimed in claim 8, wherein a common measuring head model is provided for all measuring heads in method step C.

10. The method as claimed in claim 1, wherein method step C further comprises the following method steps:
Ci. recording a plurality of spatially resolved measuring head images, which at least comprise the measuring head element, from different perspectives; and
Cii. creating a measuring head model by the plurality of spatially resolved measuring head images.

11. The method as claimed in claim 1, further comprising specifying an alignment model (1′) of the measuring head, which comprises at least a part of the measuring head at least schematically, and at least one of the location according to Ei or the measurement beam propagation direction (7) according to Eii are specified in the alignment model (1′), and at least one of method step Ei or method step Eii is carried out by aligning the alignment model with the measuring head model.

12. The method as claimed in claim 11, wherein the alignment model (1′) comprises a region surrounding a measurement beam exit opening of the measuring head, and method step Ei is carried out by the alignment.

13. The method as claimed in claim 12, wherein the alignment model (1′) comprises structures of at least one of a housing of the measuring head or an enveloping geometric structure of the housing, and the method steps Ei and/or Eii are carried out by the alignment.

14. The method as claimed in claim 1, further comprising providing a measuring head model in method step C, said model having a light beam, at least as a measuring head element, and said light beam is related to the measurement beam (6) in a specified way.

15. The method as claimed in claim 1, further comprising carrying out an interferometric measurement on the measurement object (8) by the measurement beam and the interferometric measurement is evaluated taking into account a path of the measurement beam.

16. The method as claimed in claim 1, wherein an optical axis of the measurement beam running toward the measurement object and an optical axis of the measurement beam returning from the measurement object include an angle and a profile of an angle bisector is determined as the measurement beam path.

17. A measurement apparatus for interferometric measurement of a measurement object, the measurement apparatus comprising:
one or more beam sources configured to generate at least one measurement beam and at least one reference beam,
a detector,
an evaluation unit connected to the detector configured to evaluate measurement signals from the detector, an image recording unit,
the measurement apparatus is configured to guide the measurement beam to at least one measurement point on the measurement object and to superimpose the measurement beam, which has been at least partially reflected or scattered by the measurement object, and the reference beam on a detection surface of the detector such that a superimposition or interference signal between measurement beam and reference beam is measurable by the detector,
the evaluation unit (9) is configured to determine the beam path of the measurement beam, and is configured to:
A. record a plurality of spatially resolved measurement object images of at least one measurement surface of the measurement object from different perspectives by the image recording unit;
B. create a three-dimensional measurement object model which comprises at least the measurement surface of the measurement object by the plurality of spatially resolved images of the measurement surface;
C. provide a measuring head model which comprises at least one measuring head element which is related to the measurement beam (6) in a specified way;
D. create a mapping between coordinates in the three-dimensional measurement object model and coordinates in the measuring head model with the aid of a first structure in the measurement object model and a second structure in the measuring head model and based on a spatial relationship between the first and second structure;
E. determine the measurement beam path by carrying out at least two of the following steps by the evaluation unit (9):
Ei. determining coordinates of at least one location, which is located on an optical axis defined by the measurement beam (6) or which is spatially related thereto, based on the measuring head model;
Eii. determining a direction vector specified by a measurement beam propagation direction (7) based on the measuring head model;
Eiii. determining coordinates of a measurement beam point of incidence of the measurement beam on the measurement object based on at least one spatially resolved image which comprises at least one of the measurement beam point of incidence on the measurement object (8) or at least one auxiliary beam point of incidence of an auxiliary beam with a specified spatial relation to the measurement beam (6).

18. (canceled)
